(19) United States
(12) Patent Application Publication
(10) Pub. No.: US 2002/0109734 A1
(43) Pub. Date: Aug. 15, 2002

(54) GUI processing system for performing an operation of an application which controls testing equipment

(76) Inventors: Satoshi Umezu, Tokyo (JP); Takahiro Yamaguchi, Tokyo (JP)

Correspondence Address: DELLETT AND WALTERS, 310 S.W. FOURTH AVENUE, SUITE 1101, PORTLAND, OR, 97204, US

(21) Appl. No.: 10/033,533

(22) Filed: Oct. 25, 2001

Related U.S. Application Data
(63) Continuation-in-part of application No. 09/166,698, filed on Oct. 5, 1998.

(30) Foreign Application Priority Data
Oct. 10, 1997 (JP) 9-293349

(51) Int. Cl. G09G 5/00

(52) U.S. Cl. 345/846

(57) ABSTRACT

There is disclosed a GUI processing system for performing an operation of an application which controls testing equipment for testing a device under test by displaying images such as icons or buttons on a screen, and selecting these images with use of a pointing device. A GUI part can be added or modified by adding drag controller means for implementing a visual drag-and-drop action to model view controller means, without modifying the structure of a model which is a core function of the application.

### BACKGROUND OF THE INVENTION

The present invention relates to a GUI processing system for performing an operation of an application which controls testing equipment which tests a device under test by interconnecting a test controller and one or more test units. In this specification, a device under test (DUT) means a device, system, equipment, or component of equipment to be tested by the GUI processing system according to the present invention. The test includes various actions to be conducted for known test purposes such as manufacturing evaluation, quality control, correction, calibration, alignment, adjustment, performance evaluation, diagnostics, and product incoming inspection.

In addition, a “testing apparatus” used herein includes one or more electronic equipment such as a signal generator, modulator, demodulator, input/output device, amplifier, mixer, coder, decoder, oscilloscope, strain gauge, wattmeter, multimeter, attenuator, detector, spectrum analyzer, network analyzer, semiconductor test device, synthesizer, thermostat oven, or measuring device, or a passive or active device or instrument necessary for performing evaluation, test, calibration, repair, adjustment or the like for evaluating an electronic device.

In addition, a “memory” as storage means used herein includes a RAM, ROM, or EPROM, a permanent storage device such as a floppy disk, hard disk, or CD-ROM, and a memory of other types known in the art.

A conventional testing system employs an approach for visualizing a test program to provide environment which allows a person unskilled in the testing device to use the test program. Visualization means a scheme which represents a program as a collection of pictographs called icons each of which is a program part performing acquisition of or operation on data, or display of a graph, and specifies an order of program execution by connecting displayed icons with use of a pointing device with a push button on a screen of a computer as the testing apparatus.

A user of the testing system selects these icons stored in a menu or a toolbox by pointing (pressing the push button of the pointing device, and releasing the push button without moving the pointing device) a desired one with the pointing device with a push button. Then, pointing is performed again on a window screen for programming to place the selected icon on the screen. Several predetermined connection points are set to each icon, and connection is attained by pointing a connection point of icon corresponding to a connection start and a connection point of icon corresponding to a connection end with the pointing device with the push button.

(a) Programming Through Drag-and-drop Providing Visual Feedback

First, there is described importance of drag-and-drop providing visual feedback in an operation environment using GUI (Graphical User Interface). GUI is to display an image of, for example, a push button or an icon, and to operate a range on the display with the pointing device with the push button, thereby controlling an application. For convenience of expression, a push button or icon is called a “GUI part.” GUI displays on the display an image of pointing cursor such as an arrow which moves in response to the pointing device with the push button so as to indicate a GUI part subject to processing of input information (event) from the pointing device with the push button. The drag-and-drop means an action to move (drag) the pointing device with the push button while pressing the button of the pointing device on a displayed image such as an icon, and to release (drop) the button of the pointing device on a target GUI part.

The testing system starts an application function corresponding to a relationship between the dragged GUI part and the dropped GUI part. For example, starting of a file delete function can be attained by dragging an icon with pictograph of a file to be deleted, and dropping it on an icon with pictograph of a trash box. As described above, it is arranged that a function of an application to be started can be supposed from the pictograph of a GUI part. However, it has not been easy for only the pictograph of a GUI part to determine whether or not a subject on which the dragged GUI part is being dropped is valid.

If the pictograph of the pointing cursor can be varied depending on whether or not dropping is acceptable to a GUI part under the pointing cursor, the user of the testing system can be visually guided to a GUI part on which dropping is allowed. Consequently, the operability of GUI is improved. However, such method has not existed.

In addition, if the pictograph of a dragged GUI part is arranged to follow the pointing cursor, the pictograph of the dragged GUI part can be displayed at a position adjacent to the pictograph of a dropped GUI part, whereby groping of an application function which can be started can be aided by such pictograph (FIG. 30). As described above, a drag-and-drop function providing visual feedback is important in terms of aiding groping of an application function to be provided.

However, programming in the conventional testing system does not employ the drag-and-drop, but employs a connection scheme comprising the steps of a) selecting an icon by pointing with the pointing device with the push button, and b) pointing a point determined for each icon. Although the function of icon can be supposed from the pictograph of the icon, if there are many connection points provided for each icon, there arises a problem that the system cannot be utilized unless the user fully understands the function of icon and the function of each connection point. In addition, since it is a line that follows the pointing cursor in the connecting operation, the user must always memorize the source icon and a connection point from which the line is drawn. Thus, there is a problem that it is difficult to connect icons outside a visual range of the graphics display, so that a large-scale program cannot be developed.

To implement an environment for developing a large-scale program in a testing system, an environment is necessary which can be manipulated by the drag-and-drop providing visual feedback. Thus, there is required GUI control which can implement the drag-and-drop providing visual feedback.

(b) Undo of Application Operation with GUI and Redo of Undone Operation

Even if the visual operation using GUI described above is enabled, a function for undoing an operation on an application with GUI becomes required in order to improve the operability of a testing application.

FIG. 31 shows an embodiment performing and undoing an operation on an application with GUI. In the operation, first, a DUT icon 900 is dragged and dropped on a testing apparatus icon 910 in a state where the DUT icon 900 and the testing apparatus icon 910 are displayed on a graphics display (FIG. 31(a)) (FIG. 31(b)). This operation connects the DUT icon 900 and the testing apparatus icon 910 on the graphics display (FIG. 31(c)). After the connection is performed in this manner, a predetermined test is started by a corresponding testing application. In the embodiment described above, if the operation of application is undone by GUI, the screen of the graphics display returns to a state prior to the operation shown in FIG. 31(a) where the DUT icon 900 is not connected to the testing apparatus icon 910. In addition, the testing application is terminated for the test, and returns to a state before starting the test.

If there is an operation undo function, even if the application is operated by an erroneous GUI, the state can be immediately returned to the original state. In addition, if there is a function for redoing the undone operation, even if an operation is erroneously undone, the operation can be immediately returned to a state before the operation is undone. Therefore, it is possible to implement a system in which a function of application can be groped with GUI without fear of failure. Thus, it is important for improving the operability of an application to provide an undo function for operation of an application with GUI, and a redo function for the undone operation.

The conventional testing system has error messages and a help function, but does not have an undo function for an operation and a redo function for an undone operation. Thus, when an erroneous operation is performed, the user must find a corresponding help item by referring to error messages or the like, and perform a work for undoing the operation by referring to a help message. In addition, to find an appropriate help function, the user must know a configuration of the system. Thus, there is a problem that the user cannot utilize the testing system unless he/she fully understands the testing system.

(c) Demonstration Function for GUI Operation

Similarly, if the visual operation using GUI can be attained, it is effective to demonstrate the GUI operation to inform a user of the operation method of application with GUI. Automatic demonstration of GUI operation is a function for reproducing the operation of a registered application with GUI in a frame-feed mode. In particular, if the operation procedure of an application with GUI can be automatically demonstrated, the system can be utilized without conducting training of operation for the application with GUI.

However, the conventional testing system does not support the automatic demonstration function. Therefore, the conventional testing system has a problem that the operation method of application with GUI cannot be taught to another user. In particular, since the operation of the testing system often has significant meaning in its procedure, it is convenient if its operation method can be effectively transmitted to another user.

The present invention is devised in view of the above, and is intended to provide a GUI processing system which is visual and has good operability. Specifically, the present invention is intended to (1) enable an operation of drag-and-drop providing visual feedback (first object), (2) allow undo of an operation of application with GUI (second object), (3) allow redo of an undone operation of application with GUI (third object), and (4) being capable of performing automatic demonstration of operation with GUI (fourth object).

### SUMMARY OF THE INVENTION

In one preferred embodiment of the present invention, the GUI processing system for performing an operation of an application which controls testing equipment of the present invention can attain a drag-and-drop processing by using GUI generating/managing means which is a combination of model view controller means and drag controller means, which provides visual feedback without affecting the structure of a model having core functions of an application. Thus, it is possible to attain a GUI processing system with good operability.

In addition, when the GUI generating/managing means is constituted by using the model view controller command means, there is provided a structure in which a command starts execution of operations possessed by a model or view, rather than the controller directly executing them, so that it is sufficient to restore a command in an attribute corresponding to an event of the controller even if an event or view for starting the process is modified. Thus, it is possible to freely modify a combination of the controller and the command, so that an event or view for starting the process can be easily modified without creating a new controller.

In addition, by using the above-mentioned GUI generating/managing means which is a combination of the model view controller command means and the drag controller means, it is possible to attain a drag-and-drop processing which provides visual feedback without affecting the structure of a model having core functions of an application, and to easily modify an event or view for starting a process without producing a new controller.

In addition, by using the above-mentioned GUI generating/managing means which is a combination of the model view controller command means, command execution history stack means and operation undo means, it is possible to easily undo an operation of an application with GUI. Furthermore, by constituting the GUI generating/managing means by adding command undo history stack means and operation redo means, it is possible to easily redo an undone operation with GUI. Still further, by adding command block execution means, or further adding command block edit means, it is possible to easily build a demonstration or to edit its content.

### BRIEF DESCRIPTION OF THE DRAWINGS

FIG. 1 is a diagram showing inheritance of objects;

FIG. 2 is a diagram showing a configuration of objects on a memory;

FIG. 3 is a diagram showing a structure of generic MVC;

FIG. 4 is a diagram showing a structure of MVCC according to the present invention;

FIG. 5 is a diagram showing a configuration of newly adopted model view controller command means;

FIG. 6 is a block diagram showing a configuration of testing system according to an embodiment;

FIG. 7 is a diagram showing a relationship between a lookup table and a video RAM;

FIG. 8 is a flowchart showing the operation procedure of an event detecting/informing process by an event detecting/informing section;

FIG. 9 is a block diagram of a primary object of a GUI generating/managing section corresponding to embodiment 1;

FIG. 10 is a block diagram of a primary object of a GUI generating/managing section corresponding to embodiment 1;

FIG. 11 is a diagram showing details of an icon view and an icon controller;

FIG. 12 is a flowchart showing a procedure for generating a view and a controller for an icon by an object generating/managing section;

FIG. 13 is a flowchart showing a procedure for drag start process;

FIG. 14 is a diagram showing a processing procedure during dragging;

FIG. 15 is a flowchart showing a procedure for drag end process;

FIG. 16 is a block diagram of a primary object of a GUI generating/managing section corresponding to embodiment 2;

FIG. 17 is a block diagram of a primary object of a GUI generating/managing section corresponding to embodiment 2;

FIG. 18 is a flowchart showing a procedure for command generation process by the object generating/managing section;

FIG. 19 is a flowchart showing a procedure for command generation process by the object generating/managing section;

FIG. 20 is a flowchart showing a procedure for command execution start process by the object generating/managing section;

FIG. 21 is a flowchart showing a procedure for GUI operation undo process by the object generating/managing section;

FIG. 22 is a flowchart showing a procedure for GUI operation redo process by the object generating/managing section;

FIG. 23 is a block diagram of a primary object of a GUI generating/managing section corresponding to embodiment 3;

FIG. 24 is a block diagram of a primary object of a GUI generating/managing section corresponding to embodiment 3;

FIG. 25 is a block diagram of a primary object of a GUI generating/managing section corresponding to embodiment 3;

FIG. 26 is a block diagram of a primary object of a GUI generating/managing section corresponding to embodiment 3;

FIG. 27 is a diagram showing a procedure for edit start process by a command editor;

FIG. 28 is a diagram showing a procedure for ‘additional registration process’ by the command editor;

FIG. 29 is a diagram showing a procedure for edit end process by a command editor;

FIG. 30 is a diagram for illustrating a drag-and-drop processing with an icon; and

FIG. 31 shows an embodiment performing and undoing an operation on an application with GUI.

### DESCRIPTION OF THE PREFERRED EMBODIMENTS

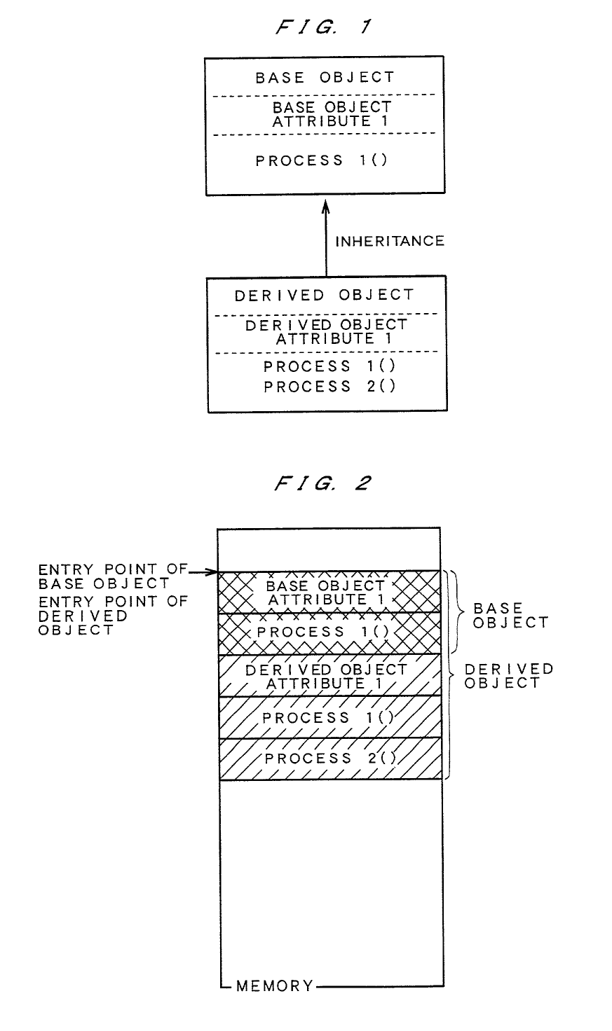

Prior to describing the present invention in detail, the concept of object is described. An object is an attribute (data) integrated with a process, and stored in a memory. FIG. 1 is a diagram showing inheritance of objects. In addition, FIG. 2 is a diagram showing a configuration of objects on a memory. As shown in FIG. 1, an arrow denoted as “inheritance” is drawn from a derived object to a base object. This indicates that the derived object is an object inherited from the base object. FIG. 2 shows a configuration of the base object and the derived object in such relationship on the memory.

A derived object has a base object at the top of a memory. Thus, an entry point of a derived object indicates the same address as that of an entry point of a base object which the derived object has therein. That is, a derived object can be treated as a base object. As described, the fact that a derived object has a base object at the top of a memory is expressed as ‘a derived object inherits a base object.’ In addition, when a derived object inherits a base object, it is expressed that the base object is called a parent object, the derived object a child object.

In an example shown in FIG. 2, two ‘process 1’ are implemented in a derived object. ‘Process 1’ near an entry point of the derived object on the memory is a process defined by a base object. Another ‘process 1’ is a process defined by the derived object.

When ‘process 1’ is requested to the derived object, ‘process 1’ defined by the derived object is executed in the following procedure.

(1) Execution of ‘process 1’ is requested to an object;

(2) The object searches the requested process from a child object to a parent object; and

(3) The object detects a process the name, return value and argument of which match those of the requested process, and executes it.

Thus, even when the derived object is treated as the base object, if execution of ‘process 1’ is requested, ‘process 1’ defined by the derived object is executed. However, even for a child object, a parent object can be executed by specifying the parent object. In addition, if ‘process 1’ is not implemented in a parent base object, execution of ‘process1’ cannot be requested to an object which is treated as the base object. It is only a process defined in the base object that can request execution to the base object.

A derived object can reference or modify the content of ‘base object attribute 1’ which a base object has.

It is important to improve operability of an application that GUI can be easily added or modified without affecting core functions of an application while maintaining the reliability of application core.

Conventionally, a GUI generating/managing approach has been implemented, in which model view controller means (MVC) allows it to easily add or modify GUI without affecting core functions of an application. MVC is used in spreadsheet software or the like. With MVC, static representation such as bar graph or pie chart can be added to a model with numerical data only by generating each view and controller such as bar graph or pie chart.

MVC allocates functions of GUI to an object (model) which stores a service, which is a core function of an application, and data, which is base of display, an object (view) for performing display, and an object (controller) receiving input from an input device, and operates GUI through cooperation of the view and the controller.

As described above, an object is data integrated with process and stored in a memory. In the following, data stored in an object is called an ‘attribute.’ It is only a process defined in an object that can request execution to the object.

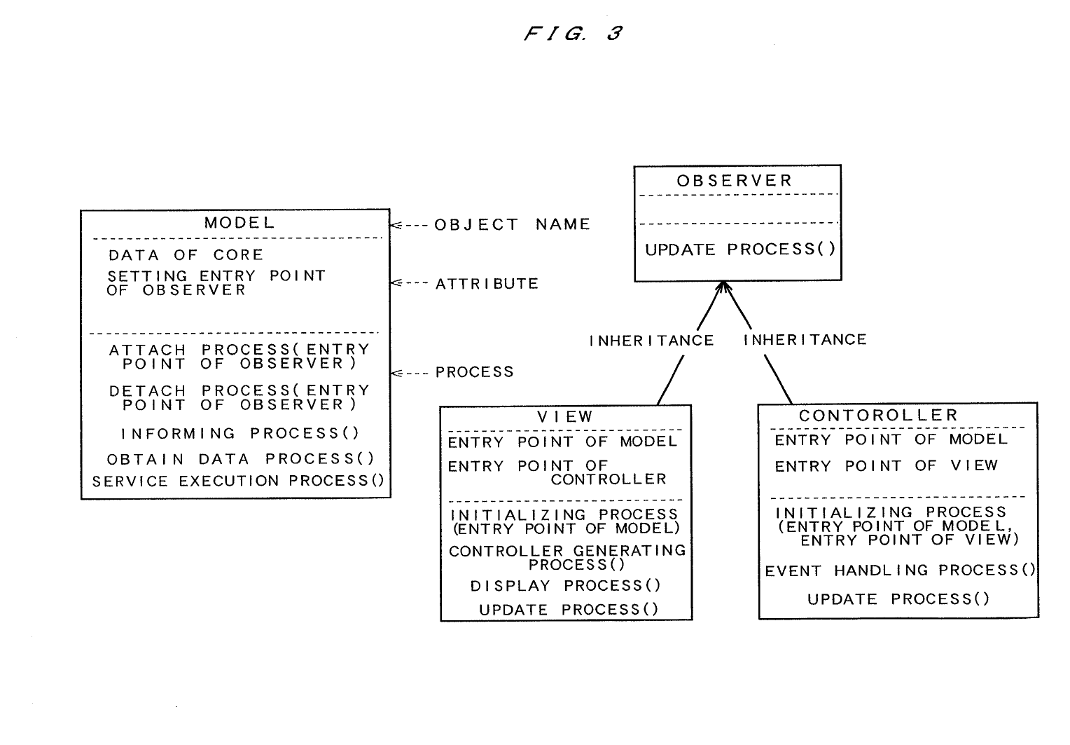

FIG. 3 is a diagram showing a structure of generic MVC.

[Model]

A model is an object for storing a service which is a core function of an application, and data which is a base of display. Then, it registers dependent views and controllers, and informs an object of the dependent view and controller of update of data which is a base of display. The model stores the dependent view and controller as an observer.

[Observer]

The observer is an object for commonly handling a view and a controller.

[View]

A view is an object for displaying information of a relevant model on the screen. Then, it references data of a model to implement an update procedure for updating display. In addition, when a view is generated, it generates and initializes a relevant controller. Objects cooperating with a view are a controller and a model.

[Controller]

A controller receives an event which is input from the pointing device with push button. Then, it converts the event into a service request to a model or a display request to a view. Objects cooperating with a controller are a view and a model.

In MVC, a view and a controller can be added without modifying the structure of a model having a core function of an application. Therefore, once a reliable model is produced, a static display can be added without degrading the reliability of core of an application.

[Detail of Objects Used for the Present Invention]

### GUI Generating/managing Means Combining Model View Controller Means and Drag Controller Means

A conventional testing system does not have a drag-and-drop operation capability providing visual feedback. Therefore, it cannot attain the first object of the present invention. In addition, if it is possible to easily attain drag-and-drop which provides visual feedback without affecting a core function of an application, a GUI part can be easily added or changed without degrading the reliability of core of the application.

Such process may be attained even if MVC is used. However, there is a following technical problem in attaining a drag-and-drop operation providing visual feedback in the MVC structure. For example, it is assumed that a drag-and-drop operation providing visual feedback is attained with an icon display. In this case, apart from a view and a controller for an icon to be dragged, it is necessary to have a view and a controller for moving a following image and changing an image of the pointing cursor as the pointing cursor moves. In MVC, the controller of icon only converts an event into a service request to the model or a display request for the view. Thus, it is impossible to directly generate a view and a controller which manage dynamic display for moving the following image and changing the image of the pointing cursor. Therefore, it generates a view and a controller so that a model of icon receives a service request from the controller of icon, and performs dynamic display.

That is, in MVC, to add to a model a view having a drag-and-drop operation capability which provides visual feedback, it is necessary to modify up to the structure of model which has a core function of an application. This is inconvenient because it degrades the reliability of the core function of the application.

To solve this problem, it is necessary to generate and control in conventional model view controller means a view and a controller in which the controller exclusively performs the drag-and-drop operation without modifying the structure of a model having the core function of the application. The present invention newly employs GUI generating/managing means (MVCC) combining model view controller means and drag controller means.

MVCC separates the view and controller of a model view controller into a static GUI part (a part such as window display displayed on the graphics display even if there is no specific operation by a user), and a dynamic GUI part(a part responsible for display during the drag-and-drop operation with the pointing device), and is arranged such that, when an action such as drag-and-drop is performed for a static GUI part, the controller of the static GUI part generates a view and a controller of the dynamic GUI part, and that processing is assigned to the view and the controller of the dynamic GUI part.

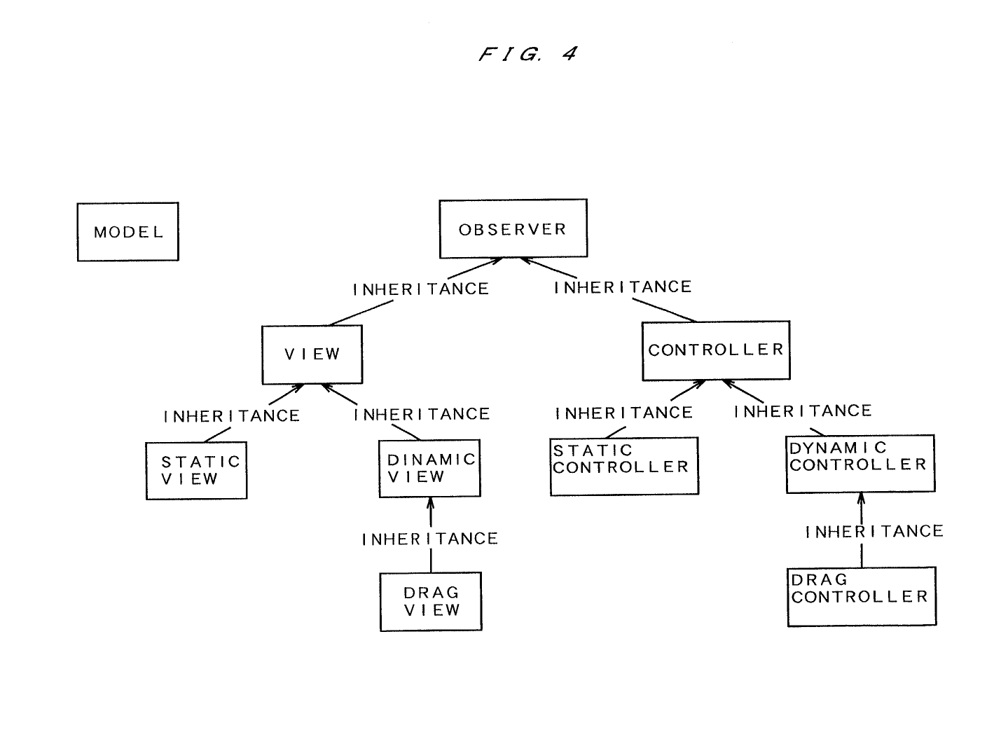

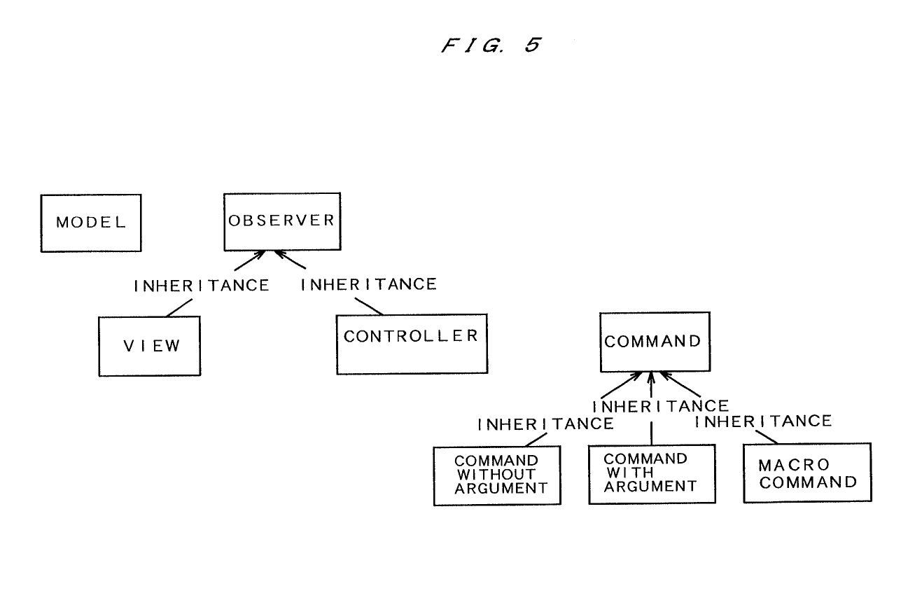

FIG. 4 is a diagram showing a structure of MVCC according to the present invention. Objects newly added as drag controller means to the model view controller means are a static view, a dynamic view, a drag view, a static controller, a dynamic controller, and a drag controller. Now, each object is briefly described.

[Static view]: It is an object for displaying an image of static part. The static view inherits the view.

[Dynamic view]: It is an object treating a dynamic image during operation of the pointing device. The dynamic view inherits the view.

[Drag view]: It is an object treating a dynamic image being dragged. The drag view inherits the dynamic view.

[Static controller]: It is an object for implementing a process of event relating to the static view. The static controller inherits the controller.

[Dynamic controller]: It is an object for implementing a process of event relating to the dynamic view. The dynamic controller inherits the controller.

[Drag controller]: It is an object for implementing a process of event relating to the drag view. The drag controller inherits the dynamic controller.

In addition, MVCC enables it to freely combine a static part and a dynamic part, or even a dynamic view and a controller. Using this MVCC enables it to easily attain drag-and-drop which provides visual feedback without affecting a core function of an application.

### Model View Controller Command Means

The conventional MVC has a structure in which a controller directly starts execution of a model or view corresponding to an event. However, MVC has a problem that a different controller should be produced for even an icon of same GUI part because of difference in execution for a model or view to be started by an event. This makes it not easy to modify an event or view starting a process for which the structure of controller should be modified.

This problem can be solved if there is an object “command” apart from the controller which starts execution of operation which a model or view has. That is, there is provided a structure in which a command starts execution of operation which a model or view has in response to a request from a controller, instead of a controller directly starting execution of operation which a model or view has. Specifically, there is provided a structure in which (1) a controller stores a command as a process corresponding to an event in a form of attribute on a memory, and (2) when an event occurs, the controller starts execution of a command corresponding to the event. Even if an event or view starting a process is modified, a modification is sufficient to store again a command in an attribute corresponding to an event of controller.

Thus, it is possible to freely modify a combination of the controller and the command, so that an event or view for starting the process can be easily modified without creating a new controller.

As a result, since what is needed is only to change the command specified by the controller means even if the combination of the model means and the view means to be subjected to the execution start process or the execution undo start process corresponding to the event is changed, and therefore, the event and the view means for starting the processes can be readily changed without any need to newly provide another controller means.

The present invention newly adopts model view controller command means. FIG. 5 is a diagram showing a configuration of newly adopted model view controller command means. Now, each object shown in FIG. 5 is described.

[Model]

A model is an object for storing a service which is a core function of an application, and data which is a base of display. Then, it registers dependent views and controllers, and informs an object of the dependent view and controller of update of data which is a base of display. The model stores the dependent view and controller as an observer.

[Observer]: The observer is an object for commonly handling a view and a controller.

[View]: A view is an object for displaying information of a relevant model on the graphics display. Then, it references data of a model to implement an update procedure for updating display. In addition, when a view is generated, it generates and initializes a controller which starts a relevant command. Objects cooperating with a view are a controller and a model which start a command.

[Controller]: A controller stores on the memory a command which is started in correspondence to an event processing as an attribute having an event processing name. A controller receives an event which is input from the pointing device with push button. Then, it starts execution of a command which is stored on the memory as an attribute having an event processing name. Objects cooperating with a controller are a view, a model and a command.

[Command]: It defines attributes and processes common to child objects such as a command without argument or a command with argument. Common processes are an execution start process and an execution undo start process.

[Command without argument]: It is an object for starting an execution process and an execution undo process which do not have an argument of model or view. The execution start process starts an execution process without an argument of model or view. In addition, the execution undo start process starts an execution undo process without an argument of model or view. A command without argument inherits a command.

[Command with argument]: It is an object for starting an execution process and an execution undo process which have an argument of model or view. The execution start process starts an execution process with an argument of model or view. In addition, the execution undo start process starts an execution undo process with an argument of model or view. A command with argument inherits a command.

[Macro command]: It is an object possessing a plurality of commands. The execution start process performs the execution start process of commands in an order of registration of them. In addition, the execution undo start process performs the execution undo start process of commands in a reverse order of registration. A macro command inherits a command.

### Command Execution History Stack Means

The command execution history stack means consists of command storage means, push means, pop means, and command execution history storage means.

The command storage means stores a command in a memory. The push means adds a command to the tail of the command storage. The pop means fetches the last added command from the command storage, and deletes it. The command execution history storage means receives from a controller a command for which the execution undo start process is executed through GUI operation, and adds the command to the command storage utilizing the push means.

The command storage means, the push means, and the pop means are implemented by a “command stack” object.

[Command stack]: It is an object for storing a command on the memory as an attribute. The command stack has a push process and a pop process. The push process adds a copy of a command provided by an argument to the tail of commands which are already stored on the memory as an attribute. The pop process returns the last one of commands which are already stored on the memory as an attribute, and deletes the last one from the attribute.

The command execution history storage means is implemented by a “GUI manager” object which stores a command stack on the memory as an attribute.

[GUI manager]: A command stack for storing an execution history and a command stack for storing an execution undo history are stored on the memory as attributes. The GUI manager has a push process, an operation execution process, and an operation execution undo process. The push process utilizes the push process of a command stack for storing an execution history to store on the memory as an attribute a command which the command stack for storing an execution history has. The operation undo process first executes a ‘pop process’ of the command stack for storing an execution history. Then, it stores a command obtained by the pop process on the memory as an attribute of the command stack for storing an undo history by utilizing the ‘push process’ of the command stack for storing an undo history. Finally, it executes the ‘execution undo start process’ of the command obtained by the ‘pop process’ executes to undo the application operation by GUI. The operation redo process first executes a ‘pop process’ of the command stack for storing an undo history. Then, it stores a command obtained by the pop process on the memory as an attribute of the command stack for storing an execution history by utilizing the ‘push process’ of the command stack for storing an execution history. Finally, it executes the ‘execution start process’ of the command obtained by the pop process to redo the undone application operation by GUI.

The GUI manager receives a command for which the execution start process is executed by the GUI operation from the controller, and causes the push process to store the received command on the memory as an attribute of the command stack for storing an execution history. As described, the command storage means, the push means and the pop means of the command execution history stack means are implemented in the command stack for storing an execution history which the GUI manager has as an attribute.

### Operation Undo Means

The operation undo means is implemented by the undo process through operation of the GUI manager described for the command execution history stack means.

### Command Undo History Stack Means

The command undo history stack means consists of command storage means, push means, pop means, and command undo history storage means. The command storage means, the push means and the pop means are implemented in the command stack described for the command execution history stack means. The command undo history storage means is implemented by the GUI manager described for the command execution history stack means. Undo of application operation by GUI is performed by the ‘operation undo process’ of the GUI manager. This operation undo process stores the command for which the ‘execution undo start process’ is performed on the memory as an attribute of the command stack for storing an execution undo history.

As described, the command storage means, the push means and the pop means of the command undo history stack means are implemented in the command stack for storing an undo history which the GUI manager has as an attribute.

### Operation Redo Means

The operation redo means is implemented by the redo process through operation of the GUI manager described for the command execution history stack means.

### Command Block Execution Means

The command block execution means selects a particular block in the command execution history which the command execution history stack means stores, and reads commands in the block in an order of registration to start execution of the command.

As a result, another user can be effectively notified of the demonstration operation and a program can be created by incorporating the operational information of the demonstration as it is.

### Command Block Edit Means

The command block edit means selects a particular command in the command execution history which the command execution history stack means stores, and generates a copy of the block. It deletes commands after a command in which the block exists, and adds a new command to the deleted section.

As a result, a program can be created simply by partially modifying the operational information of the demonstration.

The GUI processing system of the present invention uses various objects described above. Now, description is given of the operation and advantages of the GUI generating/managing means which is implemented by combining various objects.

### GUI Generating/managing Means Combining Model View Controller Means and Drag Controller Means

When the GUI generating/managing means (MVCC) combining model view controller means and drag controller means is used, it becomes possible to implement the drag-and-drop processing which provides visual feedback, without affecting the structure of a model having a core function of an application. Thus, the first object can be attained. In addition, since the drag-and-drop providing visual feedback can be easily implemented when MVCC is used, it enables the GUI processing system to provide environment for developing a large-scale program.

Even the conventional MVC can implement the drag-and-drop providing visual feedback. However, the conventional MVC is necessary to newly add a model for controlling the drag-and-drop in order to attain the drag-and-drop capability, and has to modify a static view and controller, and the structure of a model managing the static view and controller.

On the other hand, when MVCC is used, the drag-and-drop capability providing visual feedback can be attained only by reforming the event process for the static controller. Thus, total number of objects to be reformed to add the drag-and-drop capability to a static GUI part is four objects for MVC, and only one object for MVCC, so that work necessary for the modification can be significantly reduced.

That is, MVCC can add the drag-and-drop capability to a static GUI part by reforming only one-fourth objects of MVC. In addition, MVCC does not affect the structure of a model having a core function of an application through addition or change of a GUI part.

### GUI Generating/managing Means Combining Model View Controller Command Means and Drag Controller Means

When the GUI generating/managing means combining model view controller command means and drag controller means is used, the drag-and-drop processing providing visual feedback can be attained without affecting the structure of a model having a core function of an application. Thus, the first object can be attained.

MVC should newly create a controller for GUI part when a static GUI part is added. On the other hand, when the model view controller command means is utilized, the controller has a structure which stores a command corresponding to an event in a memory as an attribute. Thus, a new GUI part can be added only by registering a command in an attribute of a copy of an existing controller, without creating an object dedicated for a new GUI part which inherits the controller. In addition, when a command is arranged to have a structure which stores an entry point on the memory in which a process to be started exists on the memory as an attribute, the command can be utilized without newly creating an object inheriting a command for each process to be started.

Thus, when the model view controller command means is used, it is possible to display and control a new GUI part without creating an object of a new type. In addition, when the drag controller means is combined, the drag-and-drop capability can be added to a static part without creating any existing object. Moreover, the GUI generating/managing means combining model view controller command means and drag controller means does no affect the structure of a model having a core function of an application through addition or change of a GUI part.

### GUI Generating/managing Means Combining Model View Controller Command Means, Command Execution History Stack Means and Operation Undo Means

Functions and advantages which can be attained when using the model view controller command means are as described above.

When this model view controller command means is combined with the command execution history stack means and the operation undo means, it is possible to add the operation undo function, which is the second object. The command execution history stack means stores a command which performs the execution start process. Then, the operation undo means performs the execution undo start process for a command which the pop means of the command execution history stack means fetches. Consequently, the operation of application with GUI is cancelled. In addition, since this operation undo function has no particular limitation, the operation of application with GUI can be surely cancelled. However, sufficient memory is required to save the executed commands.

### GUI Generating/managing Means Combining Model View Controller Command Means, Drag Controller Means, Command Execution History Stack Means and Operation Undo Means

While, as described above, the drag-and-drop processing which is the first object can be attained by combining the model view controller command means and the drag controller means, the operation undo function which is the second object can be added by further combining the command execution history stack means and the operation undo means to these means. In addition, since there is no particular limitation in the operation undo function when they are combined, the operation of application with GUI can be surely cancelled. However, sufficient memory is required to save the executed commands.

### GUI Generating/managing Means Combining Model View Controller Command Means, Drag Controller Means, Command Execution History Stack Means, Operation Undo Means, Command Undo History Stack Means and Operation Redo Means

While, as described above, the drag-and-drop processing providing visual feedback and the operation undo function which are the first and second objects can be attained by combining the model view controller command means, the drag controller means, command execution history stack means and the operation undo means, the operation redo function for an undone operation which is the third object can be added by further combining the command undo history stack means and the operation redo means to these means.

The operation redo function for an undone operation can be attained by a procedure which causes the command undo history stack means to store a command on which the execution undo start process is performed, and the operation redo means to perform the execution start process for the command fetched by the pop means of the command execution history stack means. In addition, since there is no particular limitation in the operation undo function when they are combined, the operation of application with GUI can be surely cancelled. However, sufficient memory is required to save the executed commands.

Not only the third object, but also the demonstration operation which is the fourth object can be attained by using the GUI generating/managing means combining the model view controller command means, the command execution history stack means, the operation undo means, the command undo history stack means and operation redo means.

First, a command to be demonstrated is previously stored in a macro command. Then, the execution start process is performed on the macro command. Consequently, operations can be reproduced in the order in storing in the macro command. Therefore, the GUI operation can be demonstrated. Thus, it is possible to provide environment which allows a user to utilize the system without training him/her for the application operation with GUI.

### GUI Generating/managing Means Combining Model View Controller Command Means, Command Execution History Stack Means, Operation Undo Means, Command Undo History Stack Means, Operation Redo Means and Drag Controller Means

Functions and advantages which can be attained by combining the model view controller command means, the command execution history stack means, the operation undo means, the command undo history stack means, and the operation redo means are as described above, and the drag-and-drop processing providing visual feedback can be easily attained by further adding the drag controller means to them.

### GUI Generating/managing Means Combining Model View Controller Command Means, Command Execution History Stack Means, Operation Undo Means and Command Block Execution Means

Functions and advantages which can be attained by combining the model view controller command means, the command execution history stack means and the operation undo means, are as described above, and detail of a demonstration can be constructed from the command storage of the command execution history stack means by further adding the command block execution means to them, without previously creating a macro command for demonstration. Therefore, work necessary for performing the demonstration operation can be reduced.

### GUI Generating/managing Means Combining Model View Controller Command Means, Command Execution History Stack Means, Operation Undo Means, Command Block Execution Means and Drag Controller Means

Functions and advantages which can be attained by combining the model view controller command means, the command execution history stack means, the operation undo means and the command block execution means are as described above, and the drag-and-drop processing providing visual feedback can be easily attained by further adding the drag controller means to them.

### GUI Generating/managing Means Combining Model View Controller Command Means, Command Execution History Stack Means, Operation Undo Means, Command Undo History Stack Means, Operation Redo Means and Command Block Execution Means

Functions and advantages which can be attained by combining the model view controller command means, the command execution history stack means, the operation undo means, the command undo history stack means, and the operation redo means are as described above, and detail of a demonstration can be constructed from the command storage of the command execution history stack means or the command undo history stack means by further adding the command block execution means to them, without previously creating a macro command for demonstration.

### GUI Generating/managing Means Combining Model View Controller Command Means, Command Execution History Stack Means, Operation Undo Means, Command Undo-history Stack Means, Operation Redo Means, Drag Controller Means and Command Block Execution Means

Functions and advantages which can be attained by combining the model view controller command means, the command execution history stack means, the operation undo means, the command undo history stack means, the operation redo means and drag controller means are as described above, and detail of a demonstration can be constructed from the command storage of the command execution history stack means or the command undo history stack means by further adding the command block execution means to them, without previously creating a macro command for demonstration.

### GUI Generating/managing Means Combining Model View Controller Command Means, Command Execution History Stack Means, Operation Undo Means, Command Block Execution Means and Command Block Edit Means

Functions and advantages which can be attained by combining the model view controller command means, the command execution history stack means, the operation undo means and the command block execution means are as described above, and detail can be changed for the demonstration created by the command block execution means by further adding the command block edit means to them.

### GUI Generating/managing Means Combining Model View Controller Command Means, Command Execution History Stack Means, Operation Undo Means, Drag Controller Means, Command Block Execution Means and Command Block Edit Means

Functions and advantages which can be attained by combining the model view controller command means, the command execution history stack means, the operation undo means and the command block execution means are as described above, and detail can be changed for the demonstration created by the command block execution means by further adding the command block edit means to them.

### GUI Generating/managing Means Combining Model View Controller Command Means, Command Execution History Stack Means, Operation Undo Means, Command Undo History Stack Means, Operation Redo Means, Command Block Execution means and Command Block Edit Means

Functions and advantages which can be attained by combining the model view controller command means, the command execution history stack means, the operation undo means, the command undo history stack means, the operation redo means and the command block execution means are as described above, and detail can be changed for the demonstration created by the command block execution means by further adding the command block edit means to them.

### GUI Generating/managing Means Combining Model View Controller Command Means, Command Execution History Stack Means, Operation Undo Means, Command Undo History Stack Means, Operation Redo Means, Drag Controller Means, Command Block Execution Means and Command Block Edit Means

Functions and advantages which can be attained by combining the model view controller command means, the command execution history stack means, the operation undo means, the command undo history stack means, the operation redo means and the command block execution means are as described above, and detail can be changed for the demonstration created by the command block execution means by further adding the command block edit means to them.

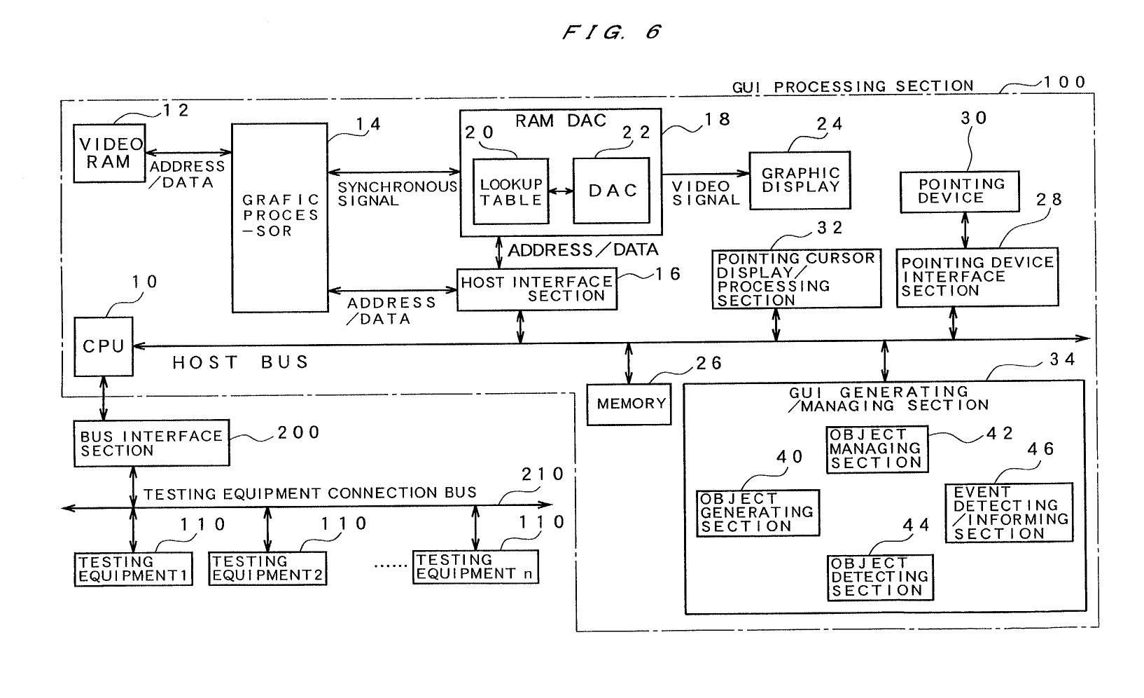

FIG. 6 shows a testing system according to an embodiment to which the present invention is applied. The testing system of the embodiment shown in the figure comprises a GUI processing section 100 and a plurality of testing equipment 110. The GUI processing section 100 is for implementing GUI environment providing visual feedback for a user, and is implemented by a personal computer, a workstation, or a processing board having functions of them or the like. In addition, the GUI processing section 100 is connected to a bus interface section 200, and to a plurality of testing equipment 110 connected to a testing equipment connection bus 210 through the bus interface section 200. The testing equipment connection bus 210 includes, for example, a computer network such as TCP/IP, a serial or parallel port, an IEEE 488 port, or a combination of them.

The GUI processing section 100 as described above comprises a CPU 10, a video RAM 12, a graphics processor 14, a host interface section 16, a RAM DAC 18, a graphics display 24, a memory, 26, a pointing device interface section 28, a pointing device 30, a pointing cursor display/processing section 32, and a GUI generating/managing section 34.

The CPU 10 is bus connected to the host interface section 16, the memory 26, the pointing device interface section 28, the pointing cursor display/processing section 32, and the GUI generating/managing section 34, and controls the entire GUI processing section 100. The video RAM 12 stores image data to be displayed on the graphics display 24 on dot basis. For example, the video RAM 12 is constituted in a packed pixel system, in which one dot on the display screen of the graphics display 24 corresponds to one pixel value with a size of one byte. The packed pixel system usually uses a memory region of the video RAM 12 corresponding to the number of dots on the display screen as a display area, and a remaining memory region (non-display area) for building or storing a GUI part such as a window image or an icon image.

The graphics processor 14 receives a command sent from the CPU 10, and sets the video RAM 12. In addition, the graphics processor 14 generates a synchronous signal necessary for screen display, reads pixel data for the display area of the video RAM 12 in synchronization with the generated synchronous signal, and sends it to the RAM DAC 18. The memory 26 is used for initializing the graphics processor 14 or the like, or for storing font or image data.

The RAM DAC 18 is for converting the pixel data sent from the graphics processor 14 into a video signal. The converted video signal is sent to the graphics display 24. The RAM DAC 18 includes a lookup table 20 and a DAC 22.

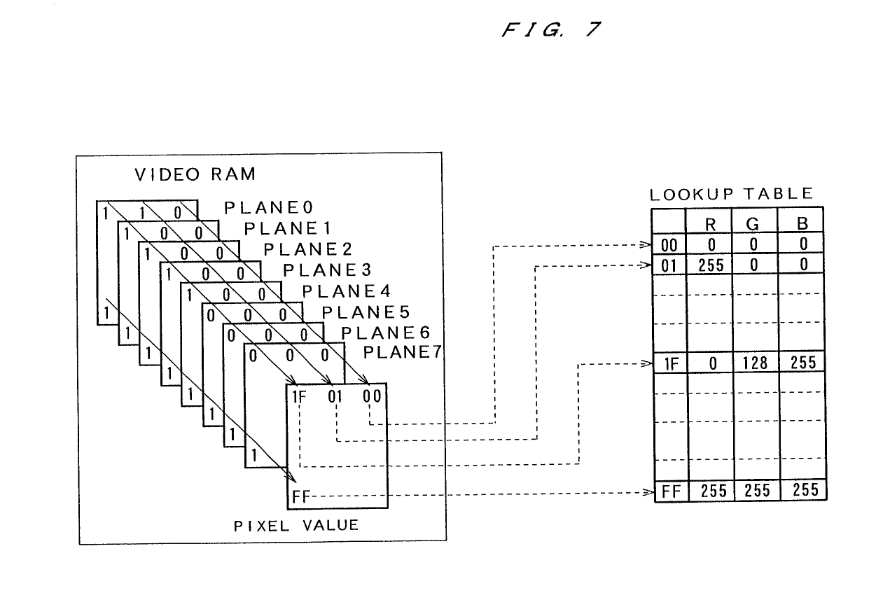

FIG. 7 is a diagram showing a relationship between the lookup table 20 and the video RAM 12. The lookup table 20 converts a pixel value read from the video RAM 12 into respective previously registered digital values of red (R), green (G) and blue (B). Each digital value of R, G and B output from the lookup table 20 is converted into an analog video signal by a digital-to-analog converter (DAC) 22, and sent to the graphics display 24. The graphics display 24 performs screen display based on the incoming video signal, thereby implementing GUI.

In addition, GUI control on the display screen of the graphics display 24 is controlled by the pointing device 30. The pointing device 30 has a push button switch, and sends movement information as well as ON/OFF information of the push button switch (for example, a state where the push button is pressed corresponding to ON state, while a state where a finger or the like is released from the push button corresponding to OFF state) to the CPU 10 through the pointing device interface section 28. The pointing cursor display/processing section 32 displays the pointing cursor on a position on the screen of the graphics display 24 pointed by the pointing device 30. Specifically, the pointing cursor display/processing section 32 stores the cursor displayed position and the position of cursor image stored in the non-display area of the video RAM 12, and transfers the cursor displayed position on the display area of the video RAM 12, thereby displaying the cursor. The pointing cursor display/processing section 32 generates a default cursor image on the non-display area of the video RAM 12 at starting of the system, and stores the region of the generated cursor image. The cursor displayed position thereafter is captured by detecting movement of the pointing device 30.

In addition, the GUI generating/managing section 34 includes an object generating section 40, an object managing section 42, an object detecting section 44, and an event detecting/informing section 46. The object generating section 40 generates an object, and stores the generated object in the memory 26. The object managing section 42 manages the object on the memory 26 generated by the object generating section 40. The management of object is performed by holding on the memory 26 a table of types and names of objects, and entry points of objects.

The object detecting section 44 has a function for specifying a type and name of an object, thereby detecting an entry point of the object. This function is implemented by referring to a table which the object managing section 42 has. In addition, the object detecting section 44 has a function detecting a controller responsible for event processing by the pointing device 30 at any positional coordinates on the screen of the graphics display 24. Detection of the controller is performed by a procedure which detects a view on the positional coordinates by referencing the table possessed by the object managing section 42 before the controller is obtained from the attribute value of the view.

The event detecting/informing section 46 detects an event from the pointing device 30, and obtains positional coordinates on the screen where the event occurs. Then, the event detecting/informing section 46 detects a controller responsible for processing of the event from the pointing device 30 with the object detecting section 44, and performs informing process of the event on the detected object. The event detected by the event detecting/informing section 46 is the one from the pointing device 30, and any one of button-down, button-up, or drag.

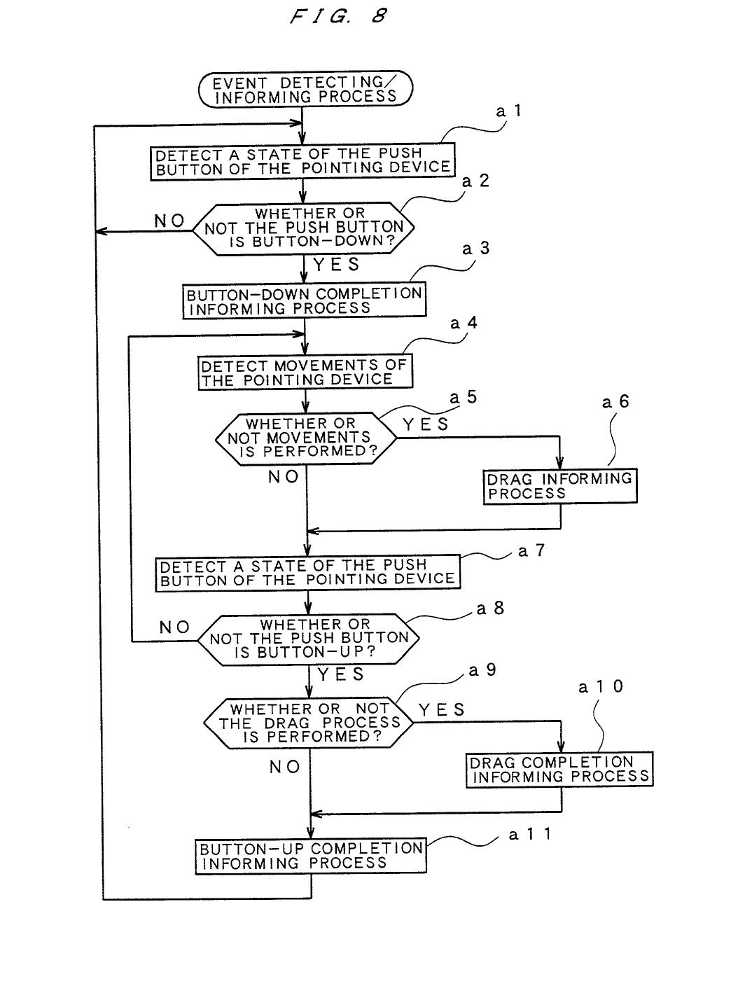

FIG. 8 is a flowchart showing the operation procedure of an event detecting/informing process by an event detecting/informing section 46. First, the event detecting/informing section 46 detects a state of the push button of the pointing device 30 (step a1), and determines whether or not the push button is pressed down (the state where the push button is pressed down being called “button-down”) (step a2). If the push button is not pressed down, the process returns to step a1, and is repeated.

If the push button is pressed down, a ‘button-down completion informing process’ is performed (step a3). In the ‘button-down completion informing process,’ the event detecting/informing section 46 detects an object for which the event processing is performed using the object detecting section 44, and executes the ‘button-down completion process’ on the detected object with the positional coordinates generated by the event as an argument.

Then, the event detecting/informing section 46 detects movement of the pointing device 30 (step a4), and determines whether or not movement is performed (step a5). If the pointing device 30 is moved, the event detecting/informing section 46 performs a ‘drag informing process’ (step a6), and, if it is not moved, detects the state of the push button of the pointing device 30 (step a7).

In the ‘drag informing process’ in step a6, the event detecting/informing section 46 detects an object on which the event processing is performed using the object detecting section 44, and causes the detected object to execute the ‘drag process’ with the positional coordinates as an argument. After the ‘drag process’ is executed, the process proceeds to step a7 where the state is detected for the push button of the pointing device 30.

Then, the event detecting/informing section 46 determines whether or not the push button is in a released state where a finger or hand of the user is released from the push button (this state being called “button-up”) based on the result of detection on the state of the push button of the pointing device 30 in step a6 (step a8). If it is not in the button-up state, the process returns to step a4 described above, and is repeated. In addition, if it is in the button-up state, the event detecting/informing section 46 determines whether or not the drag process is performed (step a9). Whether or not the drag process is performed can be determined from whether or not the pointing device 30 is moved in a state where the push button is pressed down. If the pointing device 30 is moved in a state where the push button is pressed down, it is determined that the drag process is performed, and the ‘drag completion informing process’ is performed (step a10). On the other hand, if the drag process is not performed, then a ‘button-up completion informing process’ is performed (step a11).

In the ‘drag completion informing process’ in step a10, the event detecting/informing section 46 detects an object on which the event processing is performed using the object detecting section 44, and causes the detected object to execute the ‘drag completion informing process’ with the positional coordinates of the pointing cursor as an argument. In addition, in the ‘button-up completion informing process’ in step a11, the event detecting/informing section 46 detects an object on which the event processing is performed using the object detecting section 44, and causes the detected object to execute the ‘button-up completion informing process’ with the positional coordinates of the pointing cursor in the button-up state as an argument. Then, the process returns to step a1 described above for repetition.

Now, the outline of the object generating section 40 is described based on each embodiment.

[Embodiment 1]

Embodiment 1 corresponds to a case where the GUI generating/managing section 34 is provided with functions of model view controller means and drag controller means (MVCC), and illustrates a method for implementing a drag-and-drop processing providing visual feedback.

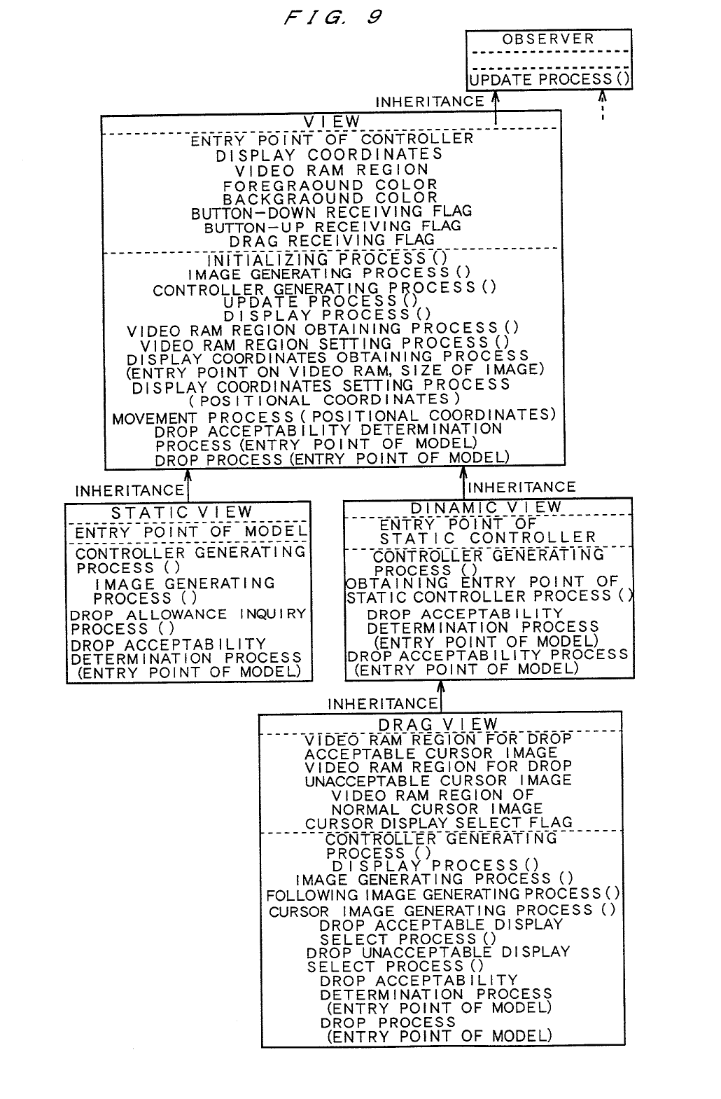

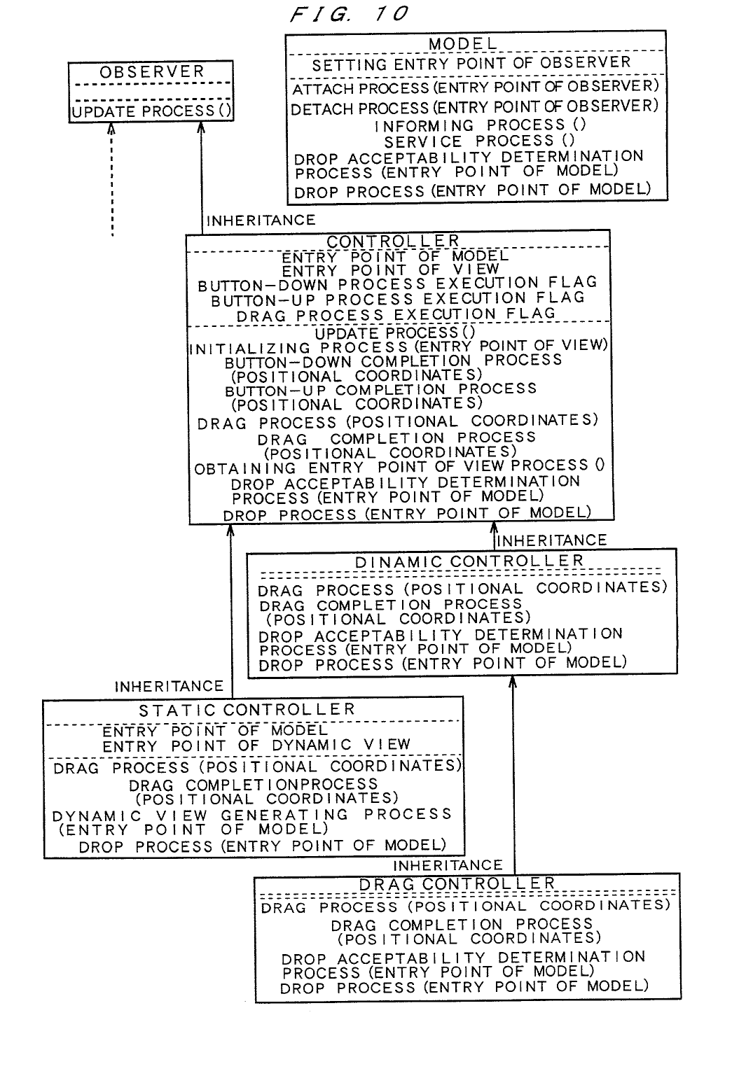

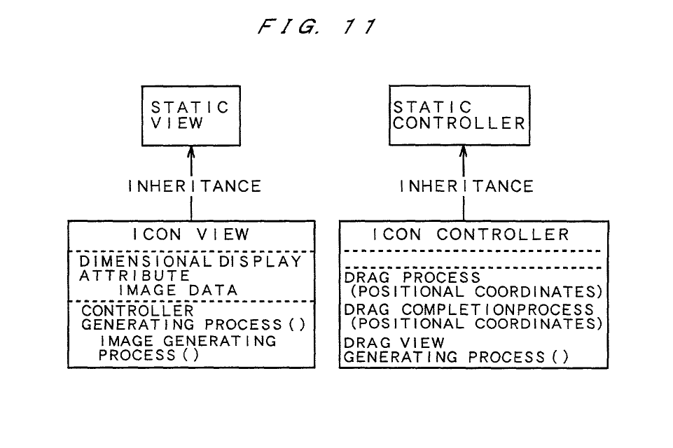

FIGS. 9 and 10 are block diagrams of a primary object of a GUI generating/managing section 34 corresponding to embodiment 1. Here, an “observer” commonly shown in FIGS. 9 and 10 represents the same one. FIGS. 9 and 10 together show a configuration of primary object of the GUI generating/managing section 34. The feature of each object and object(s) for cooperation are described in the following.

“Observer”:

[Feature]

The observer is an object for commonly handling the view and the controller. It defines an ‘update process’ which the view and the controller commonly possess.

[Object for Cooperation]: Model

[Attribute]: None

[Process]

Update process ( )

The ‘update process’ of the observer does nothing. It is a process prepared such that it can execute the ‘update process’ for a child object when the child object is treated as an observer.

“Model”:

[Feature]

It provides core functions of an application. It stores a dependent view and controller on the memory as an attribute. It informs the dependent view and controller of modification of data. It accommodates an inquiry on whether or not a drop request is accepted.

[Object for Cooperation]: View, Controller

[Attribute]

Setting entry point of observer

An entry point of observer is address data of an observer on the memory. Setting an entry point of observer is to have an entry point in an array structure.

[Process]

Attach process (entry point of observer)

The attach process registers an observer provided by a setting argument in a ‘setting entry point of observer’ attribute.

Detach process (entry point of observer)

The detach process deletes an observer provided by an argument from a ‘setting entry point of observer’ attribute.

Informing process ( )

The informing process is a process for executing the ‘update process’ of an observer. A subject on which the process is executed is an observer stored on the memory as a ‘setting entry point of observer’ attribute.

Service process ( )

It is a service process provided by a model. Detail of process depends on a child observer.

Drop acceptability determination process (entry point of model)

The drop acceptability determination process is a process for determining whether or not a model provided by an argument can be dropped.

Drop process (entry point of model)

It is a process when an icon is dropped on a view depending on a model with the drag-and-drop of the icon. A model of the dropped icon is specified as an argument. Detail of process depends on a child object.

“View”:

[Feature]

It is a process for defining an attribute and a process common to a static view and a dynamic view. It implements the update process. It generates a relevant controller.

[Object for Cooperation]: Controller

[Attribute]

Entry point of controller

It is a region for storing an entry point of a controller operating in pair of a view on the memory.

Display coordinates

The display coordinates represent a region for storing positional coordinates (x, y) on the graphics display (the display screen of the graphics display 24) for displaying an image. The positional coordinates on the graphics display agree with the coordinates for the display area of the video RAM 12.

Video RAM region

The video RAM region is a region for storing an entry point and size of an image produced in the non-display area of the video RAM.

Foreground color

The foreground color is a region for storing the color of an image in RGB values.

Background color

The background color is a region for storing the background color of an image in RGB values.

Button-down receiving flag

The button-down receiving flag is integer type data. The button-down receiving flag becomes 1 when allowing button-down, and 0 when not allowing button-down.

Button-up receiving flag

The button-up receiving flag is integer type data. The button-up receiving flag becomes 1 when allowing button-up, and 0 when not allowing button-up.

Drag receiving flag

The drag receiving flag is integer type data. The drag receiving flag becomes 1 when allowing dragging, and 0 when not allowing dragging.

[Process]

Initializing process ( )

It is a process for clearing an attribute, and executing an ‘image generating process’ and a ‘controller generating process.’

Image generating process ( )

It is a process for generating an image in the non-display area of the video RAM 12 in pixel values. The ‘image generating process’ references the lookup table 20, and obtains pixel values corresponding to color of a GUI image to be produced. If the lookup table 20 does not contain corresponding color information, a view establishes new color values in empty regions of the lookup table 20, and obtains these pixel values. Then, the ‘image generating process’ generates an icon image in a continuous non-display area in the video RAM 12 based on the obtained pixel values. Then, this area is stored in the memory 26 as a ‘video RAM region’ attribute. An image to be produced depends on a child object.

Controller generating process ( )

It is a process for generating a relevant controller, and initializing the controller.

Update process ( )

It is a process for executing the display process.

Display process ( )

It is a process for transferring an image in the video RAM region indicated by the video RAM region attribute to the display area of the video RAM 12.

Video RAM region obtaining process ( )

It is a process for reading a value stored in the memory 26 as a video RAM region attribute.

Video RAM region setting process (entry point on video RAM 12, size of image)

It is a process for setting a value of argument in the video RAM region attribute.

Display coordinates obtaining process ( )

It is a process for reading a display coordinates attribute.

Display coordinates setting process (positional coordinates)

It is a process for setting a value of argument in the display coordinates attribute.

Movement process (positional coordinates)

It stores positional coordinates provided by an argument in the ‘display coordinates’ attribute. Then, it implements the ‘update process.’

“Static view”

[Feature]

It displays information of a model to the user. It generates and initializes a relevant static controller. It implements the update process. It confirms acceptance of a drop request with a model, and informs the inquiring dynamic controller of the result.

[Object for Cooperation]: Static Controller, Model, Dynamic Controller

[Attribute]

Entry point of model

It is a region for storing an entry point of a model having core data for display on the memory 26.

[Process]

Controller generating process ( )

It generates a relevant static controller. Then, it initializes the static controller. Moreover, it stores an entry point of the model in a ‘entry point of model’ attribute of the static controller.

Image generating process ( )

It is a process for generating an image in the non-display area of the video RAM 12 in pixel values. An image to be produced depends on a child object. It stores the generated region the memory 26 as a ‘video RAM region’ attribute of a parent view.

Drop allowance inquiry process ( )

It performs a ‘drop acceptability determination process’ of a model managing an image on the top surface under the pointing cursor.

“Dynamic view”:

[Feature]

It defines an attribute and process common to a dynamic view such as dragging. It generates and initializes a relevant dynamic controller.

[Object for Cooperation]: Dynamic Controller, Static Controller

[Attribute]

Entry point of static controller

It is a region for storing an entry point of a static controller generating the dynamic view on the memory 26.

[Process]

Controller generating process ( )

It generates a relevant dynamic controller, and performs an ‘initializing process’ for the dynamic controller.

Obtaining entry point of static controller process ( )

It reads an entry point which is registered in the ‘entry point of the static controller’ attribute.

“Drag view”:

[Feature]

It displays information on dragging operation. It changes an image of pointing cursor. It displays an image following the cursor adjacent to the pointing cursor. It generates and initializes a relevant drag controller.

[Object for Cooperation]: Drag Controller, Static View

[Attribute]

Video RAM region for drop acceptable cursor image

It stores address data for a cursor image indicating drop being acceptable on the non-display area of the video RAM 12.

Video RAM region for drop unacceptable cursor image

It stores address data for a cursor image indicating drop being unacceptable on the non-display area of the video RAM 12.

Video RAM region of normal cursor image

It stores address data of an image of a cursor, which is utilized prior to starting of a drag view, on the non-display area of the video RAM 12.

Cursor display select flag

The cursor display select flag is integer type data. The cursor display select flag becomes 1 when the pointing cursor is made a cursor image indicating drop acceptable, and 0 when it is made a cursor image indicating drop unacceptable.

[Process]

Controller generating process ( )

It generates a relevant drag controller, and performs an ‘initializing process’ for the drag controller.

Display process ( )

The display process references the cursor display select flag. If the cursor display select flag is 1, it stores a ‘video RAM region of drop acceptable cursor image’ attribute in the pointing cursor display processing section 32. If the cursor display select flag is 0, it stores a ‘video RAM region of drop unacceptable cursor image’ attribute in the pointing cursor display processing section 32. In addition, the display process transmits the image stored in the ‘video RAM storage region’ attribute to the display area of video RAM 12 indicated by a ‘display image,’ and displays an image following the cursor.

Image generating process ( )

It performs a ‘following image setting process’ and a ‘cursor image generating process.’

Following image setting process ( )

It stores an image following the cursor in the ‘video RAM region’ attribute of a view which is a parent object. Data to be stored is an address of the non-display area of the video RAM 12.

Cursor image generating process ( )

It generates a cursor image indicating drop acceptable in the non-display area of the video RAM 12, and registers it in the ‘video RAM region of drop acceptable cursor image’ attribute. In addition, it generates a cursor image indicating drop unacceptable in the non-display area of the video RAM 12, and registers it in the ‘video RAM region of drop unacceptable cursor image’ attribute.

Drop acceptable display select process ( )

It turns the ‘cursor display select flag’ attribute to 1.

Drop unacceptable display select process ( )

It turns the ‘cursor display select flag’ attribute to 0.

“Controller”:

[Feature]

It defines an attribute and a process common to a static controller and a dynamic controller. It receives an event input by the user. It converts the event into a service request to a model or a display request to a view. It implements the update process.

[Object for Cooperation]: View

[Attribute]

Entry point of view

It is an entry point of a view on the memory 26.

Button-down process execution flag

The button-down process execution flag is integer type data. It becomes 1 when allowing the button-down process, and 0 when not allowing it.

Button-up process execution flag

The button-up process execution flag is integer type data. It becomes 1 when allowing the button-up process, and 0 when not allowing it.

Drag process execution flag

The drag process execution flag is integer type data. It becomes 1 when allowing the drag process, and 0 when not allowing it.

[Process]

Update process ( )

It sets the ‘button-down receiving flag,’ ‘button-up receiving flag’ and ‘drag receiving flag’ attributes of the view indicated by the ‘entry point of view’ attribute in the ‘button-down process execution flag,’ ‘button-up process execution flag’ and ‘drag process execution flag’ attributes.

Initializing process (entry point of view)

It stores the entry point of view specified by an argument in the ‘entry point of view’ attribute.

Button-down completion process (positional coordinates)

It is a process when button-down is completed. It runs only when the ‘button-down process execution flag’ attribute is 1. The ‘button-down completion process’ of the controller itself does nothing. It is a process prepared so that the ‘button-down completion process’ of the child object of the controller can be executed.

Button-up completion process (positional coordinates)

It is a process when button-up is completed. It runs only when the ‘button-up process execution flag’ attribute is 1. The ‘button-up completion process’ of the controller itself does nothing. It is a process prepared so that the ‘button-up completion process’ of the child object of the controller can be executed.

Drag process (positional coordinates)

It is a process during the pointing device 30 being dragged. It runs only when the ‘drag process execution flag’ attribute is 1. The ‘drag process’ of the controller itself does nothing. It is a process prepared so that the ‘drag process’ of the child object of the controller can be executed.

Drag completion process (positional coordinates)

It is a process when dragging is completed. It performs the ‘drop process’ of the model. It runs only when the ‘drag process execution flag’ attribute is 1.

“Static controller”

[Feature]

It receives an event input by the user. It converts the event into a service request to a model or a display request to a static view. It implements the update procedure. It generates a dynamic view.

[Object for Cooperation]: Static View, Model, Dynamic View

[Attribute]

Entry point of model

It is an entry point of a model on the memory 26.

Entry point of dynamic view

It is an entry point of a dynamic view on the memory 26.

[Process]

Drag process (positional coordinates)

It performs the ‘dynamic view generating process.’

Drag completion process (positional coordinates)

It deletes a dynamic view and a dynamic controller. Then, it executes the ‘drop acceptability determination process’ of a model managing an image on the positional coordinates of an argument. If the drop acceptability determination shows that drop is acceptable, it executes the ‘drag completion process’ of the parent controller, and ends the drag completion process. If drop is impossible, it terminates the process.

Dynamic view generating process ( )

It generates a dynamic view, and performs the ‘initializing process’ of the dynamic view. Then, it stores the entry point of the generated dynamic view in the ‘entry point of dynamic view’ attribute. In addition, it stores the entry point of the static controller itself in the ‘entry point of static controller’ attribute of the dynamic view.

“Dynamic controller”:

[Feature]

It defines an attribute and process common to a dynamic controller such as dragging. It receives an event input by the user. It converts the event into a display request to the dynamic view.

[Object for Cooperation]: Dynamic View and Static View

[Attribute]: None

[Process]

Drag process (positional coordinates)

The ‘drag process’ of the dynamic controller does nothing. It is a process prepared so that the ‘drag process’ of the child object such as the drag controller can be executed.

Drag completion process (positional coordinates)

The ‘drag completion process’ of the dynamic controller does nothing. It is a process prepared so that the ‘drag completion process’ of the child object such as the drag controller can be executed.

“Drag controller”:

[Feature]

It converts an event from the start of dragging to releasing of the button of the pointing device 30 into a process for the drag view. When dropped, it sends positional information to a model corresponding to the dropped view, and requests the drop process. It implements the update procedure.

[Object for Cooperation]: Drag View

[Attribute]: None

[Process]

Drag process (positional coordinates)

It performs the ‘drop acceptability inquiry process,’ of the view, and confirms acceptability of drop. The subject view is a view managing a front-most image under the pointing cursor. If dropping to the view is acceptable, it performs the ‘drop acceptable display select process’ of the drag view. On the contrary, if dropping to the view is impossible, it performs the ‘drop unacceptable display select process’ of the drag view.

Drag completion process (positional coordinates)

It performs the ‘drag completion process’ of the static view which generates the drag view. This static view is obtained by performing the ‘obtain entry point of static view process’ of the drag view.

MVCC attains the drag-and-drop of icon by utilizing various primary objects described above. An icon consists of an icon view inheriting the static view and an icon controller inheriting the static controller.

FIG. 11 is a diagram showing details of an icon view and an icon controller. The following is features and cooperating objects of an icon view and an icon controller shown in the figure.

“Icon view”:

[Feature]

It displays an icon image. It generates and initializes a relevant icon controller.

[Object for Cooperation]: Icon Controller

[Attribute]

Image data

It is a region for storing a bit map of a picture displayed on an icon.

Two-dimensional display attribute

It is a region for storing sizes in x- and y-axes.

[Process]

Controller generating process ( )

It generates a dependent icon controller, and performs the ‘initializing process’ of the controller.

Image generating process ( )

The image generating process of icon view generates an image of icon in the non-display area of video RAM 12. The size of icon image is determined by the two-dimensional display attribute. In addition, the image uses bit map data of the ‘image data’ attribute. The non-display area of video RAM 12 storing the produced image is stored in the ‘video RAM region’ attribute of the view.

“Icon controller”:

[Feature]

It receives an event for an icon image input by the user. It implements the drag completion process. It generates a drag view.

[Object for Cooperation]: Icon View, Drag View

[Attribute]: None

[Process]

Drag event process (positional coordinates)

It is a process for performing the ‘drag view generating process.’

Drag completion process (positional coordinates)

It deletes a drag view and a drag controller which are generated in starting dragging. Then, it performs the ‘drop acceptability inquiry process’ of the view which manages an image on positional coordinates specified by an argument. If drop is acceptable as the result of the ‘drop acceptability inquiry process’ of the view, it performs the ‘drag completion process’ of the parent controller. If drop is impossible as the result of the ‘drop acceptability inquiry process’ of the view it ends the process.

Drag view generating process ( )

It generates a drag view, and performs the ‘initializing process’ of the drag view. Then, it stores the entry point of the generated drag view in the ‘entry point of dynamic view’ attribute. In addition, it stores the entry point of the icon controller itself in the ‘entry point of static controller’ attribute of the drag view.

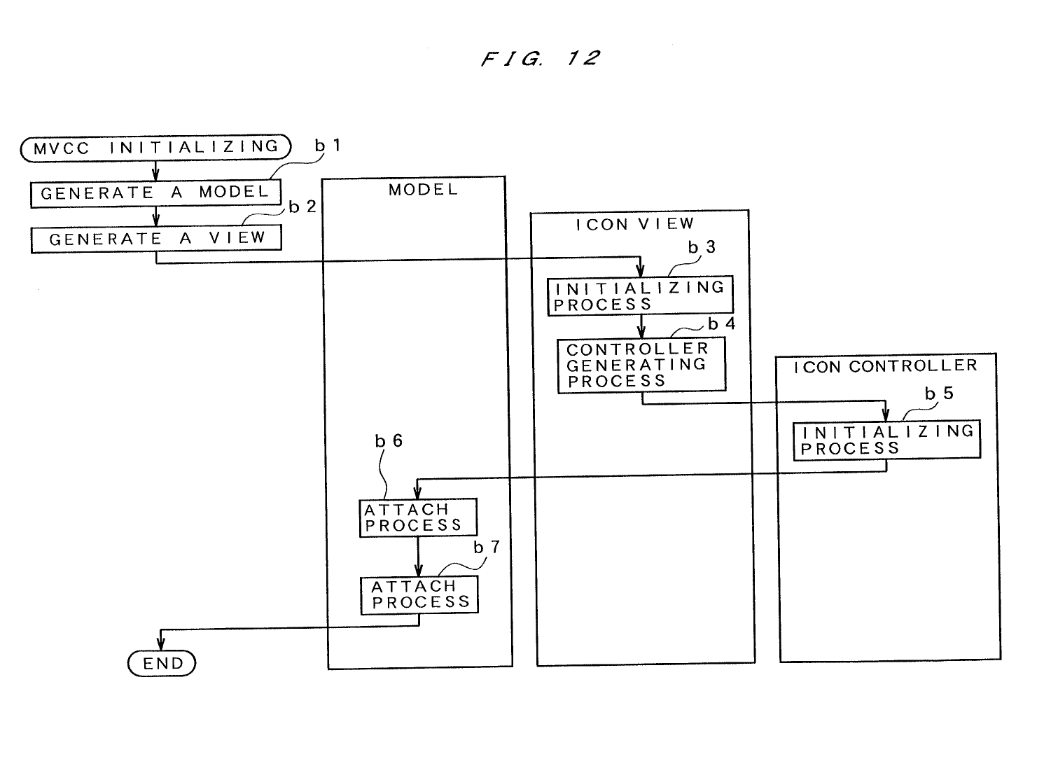

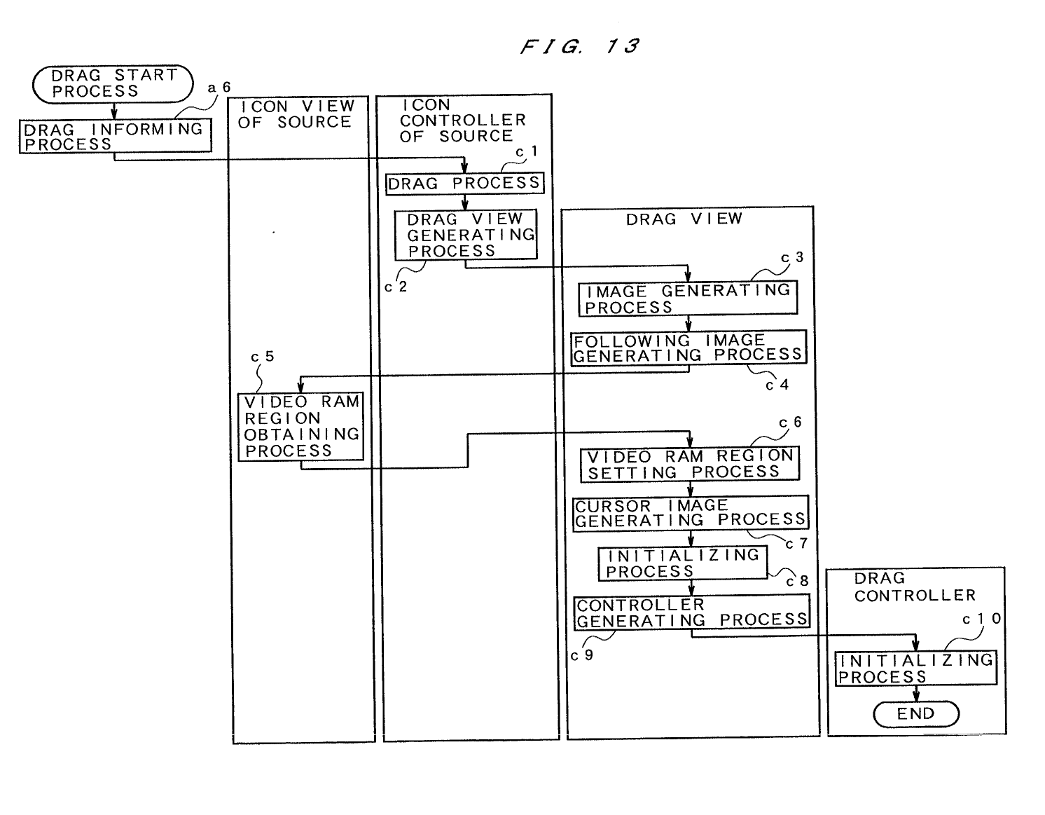

FIG. 12 is a flowchart showing a procedure for generating a view and a controller for an icon by an object generating/managing section 34.

First, MVCC generates a model (step b1), and then generates an icon view (step b2) before initializing the generated icon view (step b3). However, since the icon view itself does not have the initializing process, it is the initializing process of the parent object that is executed. In addition, it sets the entry point of the model generated in step b1 in the ‘entry point of model’ attribute of the static view. This static view is the parent object of the icon view.

In the initializing process of view, MVCC performs the controller generating process (step b4). The controller generating process which is performed is the controller generating process of the icon view because the icon view has a process having the same name and argument. The controller generating process of icon view generates an icon controller, and stores the entry point of the generated icon controller on the memory 26 as the ‘entry point of controller’ attribute.

Then, MVCC performs the initializing process of the icon controller (step b5). In this case, it is the initializing process of the controller that is performed. It is the entry point of icon view that is specified as the argument of the initializing process. It is because the icon view can be treated as the parent object. Then, it sets the entry point of the model generated in step b1 in the ‘entry point of model’ attribute of the static controller. This static controller is the parent object of the icon controller. The initializing process of the controller stores the entry point of icon view specified as the argument in the ‘entry point of view’ attribute.

Then, MVCC provides the entry point of icon view to the argument, and performs the attach process of the model (step b6). The attach process of model stores the entry point of icon view in the ‘setting entry point of observer’ attribute as the entry point of the observer.

Finally, MVCC provides the entry point of the icon controller to the argument, and performs the attach process of the model (step b7). The attach process of model stores the entry point of icon controller in the ‘setting entry point of observer’ attribute as the entry point of the observer. The above is a sequence for generating a view and a controller of an icon by MVCC.

Now, there is shown an example of the drag-and-drop processing of icon with MVCC. This example shows a process to drag and drop an icon of a source (for example, DUT) displayed on the graphics display to an icon of a target (for example, the testing equipment 110). The icon of source consists of an icon view belonging to a model of the source and an icon controller. In addition, the icon of target consists of an icon view belonging to a model of the target and an icon controller.

(1) Drag start process

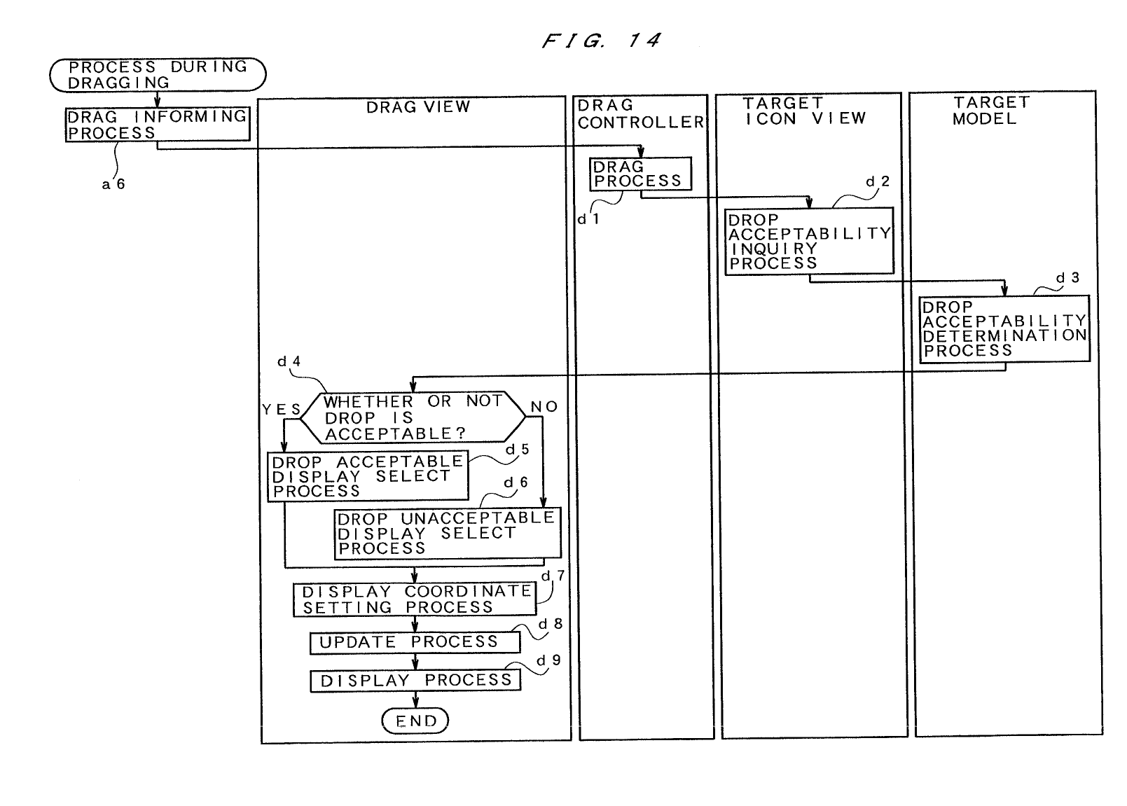

FIG. 13 is a flowchart showing a procedure for drag start process.

Step a6 is the ‘drag informing process’ contained in the operation procedure shown in FIG. 8. When the ‘drag informing process’ is performed, MVCC implements the ‘drag process’ of the icon controller of source (step c1), which in turn performs the ‘drag view generating process’ (step c2). In addition, MVCC generates a drag view in this ‘drag view generating process,’ and performs the ‘image generating process’ with the generated drag view (step c3). The ‘image generating process’ generates a following image, a cursor image when drop is acceptable, and a cursor image when drop is impossible.

In the ‘image generating process,’ MVCC first performs the ‘following image generating process’ (step c4), which in turn performs the ‘video RAM region obtaining process’ of the source icon view (step c5) to obtain a video RAM region for the source icon image.

Then, MVCC performs the ‘video RAM region setting process’ (step c6) to copy the ‘video RAM region’ attribute of the source icon to the ‘video RAM region’ attribute of the drag view.

In addition, MVCC performs the ‘cursor image generating process’ (step c7) to generate a cursor image when drop is acceptable or a cursor image when drop is impossible in the non-display area of the video RAM 12. The ‘cursor image generating process’ stores information of the generated cursor image when drop is acceptable in a ‘video RAM region of drop acceptable cursor image’ attribute. It also stores information of the generated cursor image when drop is impossible in a ‘video RAM region of drop unacceptable cursor image’ attribute.

In addition, the ‘dynamic view generating process’ generates a drag view, and then performs the ‘initializing process’ of the drag view (step c8). The ‘initializing process’ of the drag view performs the ‘controller generating process’ of the drag view (step c9). The ‘controller generating process’ of the drag view generates a controller, and the ‘initializing process’ of the drag controller is performed (step c10). The ‘initializing process’ of the drag controller performs a process for registering an entry point of the drag view in the ‘entry point of view’ attribute.

(2) Process during dragging

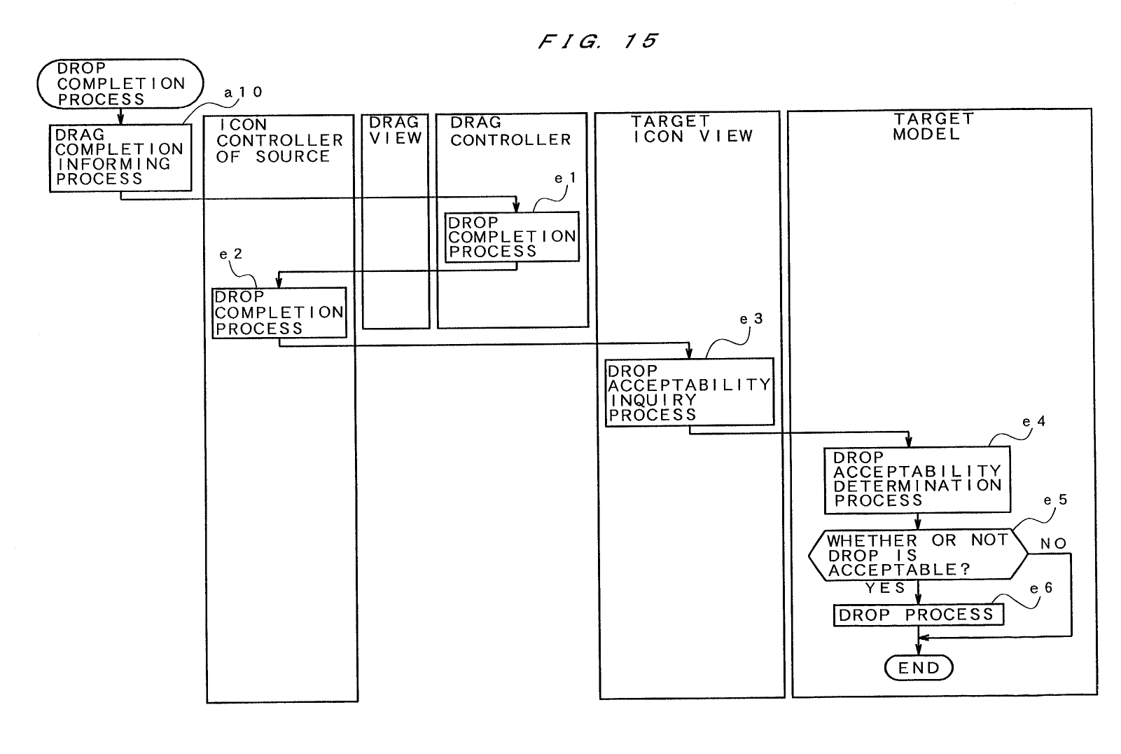

FIG. 14 is a diagram showing a processing procedure during dragging.

Step a6 is the ‘drag informing process’ contained in the operation procedure shown in FIG. 8. When the ‘drag informing process’ is performed, the ‘drag process’ of the drag controller is performed (step d1). When a static controller generates the drag view, the object detecting section 44 detects the drag controller. Then, the event detecting/informing section 46 performs the drag informing process of the drag controller.

The ‘drag process’ of the drag controller inquires acceptability of drag from the icon view of target, and changes the attribute of the drag view. First, the ‘drag process’ of the drag controller performs the ‘drop acceptability inquiry process’ (step d2). The subject of the inquiry process is an object inheriting a static view which manages an image under the pointing cursor. In addition, the ‘drag process’ of the drag controller detects the static view which manages an image under the pointing cursor using the object detecting section 44 based on the positional coordinates of argument. In this example, the subject of inquiry is an icon view of target inheriting the static view.

The ‘drop acceptability inquiry process’ of the target model icon view performs the ‘drop acceptability determination process’ of the target model (step d3). Here, the model of target is stored in the ‘entry point of model’ attribute of the target icon view.

Then, in the ‘drag process’ of the drag controller, the acceptability of drop is determined based on the result of the ‘drop acceptability inquiry process’ of the target icon view (step d4). If drop is acceptable, the ‘drop acceptable display select process’ of the drag view is performed in the ‘drag process’ of the drag controller (step d5). If drop is unacceptable, the ‘drop unacceptable display select process’ of the drag view is performed in the ‘drag process’ of the drag controller (step d6).

In the ‘drop acceptable display select process’ of the drag view, the cursor display select flag attribute of the drag view is set to 1. In addition, in the ‘drop unacceptable display select process’ of the drag view, the cursor display select flag attribute of the drag view is set to 0.

Finally, in the ‘drag process’ of the drag controller performed are the ‘display coordinate setting process’ of the drag view (step d7) and the ‘update process’ of the drag view (step d8). Coordinates set in the ‘display coordinate setting process’ are the positional coordinates of argument specified in the ‘drag process.’ In the ‘update process’ of the drag view, the ‘display process’ of the drag view is performed (step d9).

(3) Drag completion process

FIG. 15 is a diagram showing a procedure for drag end process.

Step a10 is the ‘drag completion informing process’ contained in the operation procedure shown in FIG. 8. When the ‘drag completion in forming process’ is performed, the ‘drag completion process’ of the drag controller is performed (step e1). The ‘drag completion process’ of the drag controller references the ‘entry point of static controller’ attribute, and performs the ‘drag completion process’ of the source icon controller (step e2).

The ‘drag completion process’ of the source icon controller first deletes the dynamic view and the dynamic controller, and then the ‘drop acceptability inquiry process’ of the target icon view is performed (step e3). The subject of the inquiry process is an object inheriting a static view which manages an image under the pointing cursor.

Then, it executes the ‘drop acceptability determination process’ of a model managing an image on the positional coordinates of an argument (step e4), and determines drop acceptability based on the result (step e5). If drop is acceptable as the result of drop acceptability determination, the ‘drop process’ of the model is performed (step e6), thereby completing the drag completion process. If drop is unacceptable, the drop completion process is completed as is.

[Embodiment 2]

Embodiment 2 corresponds to a case where the GUI generating/managing section 34 is provided with functions of model view controller command means, command execution history stack means, operation undo means, command undo history stack means and operation redo means, and illustrates a method for implementing an operation undo process, aredo process for undone operation, and an automatic demonstration process of the GUI operation.

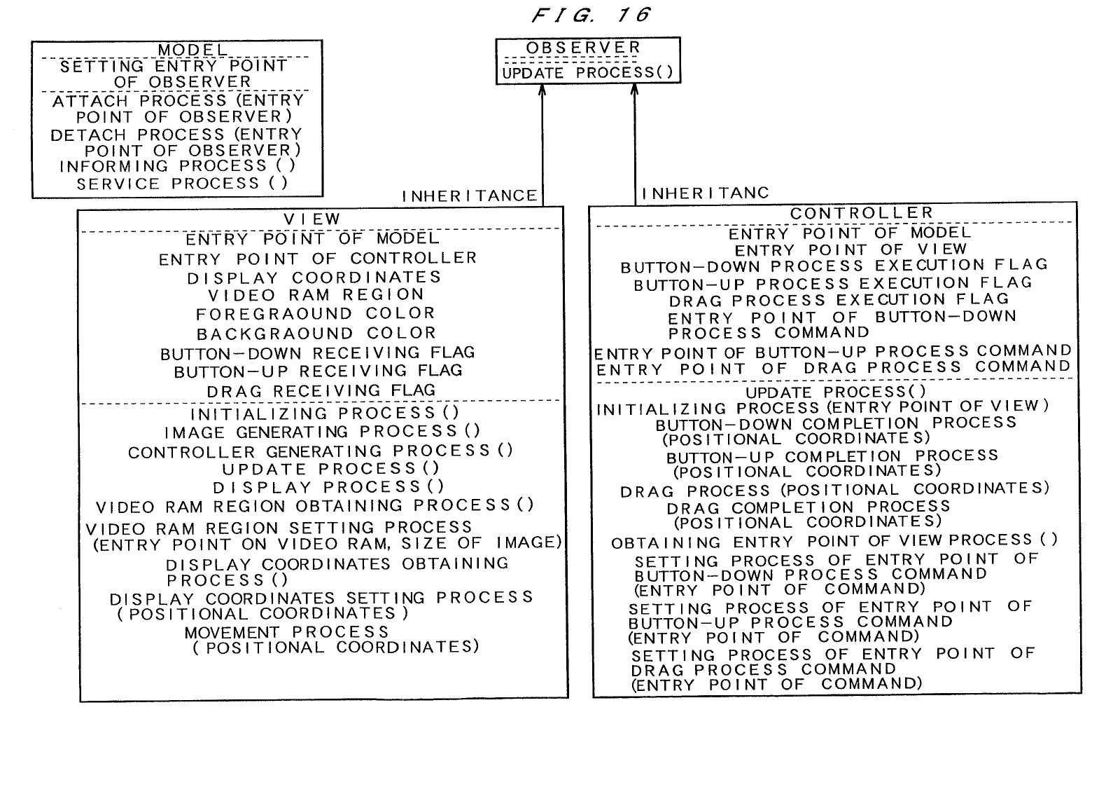

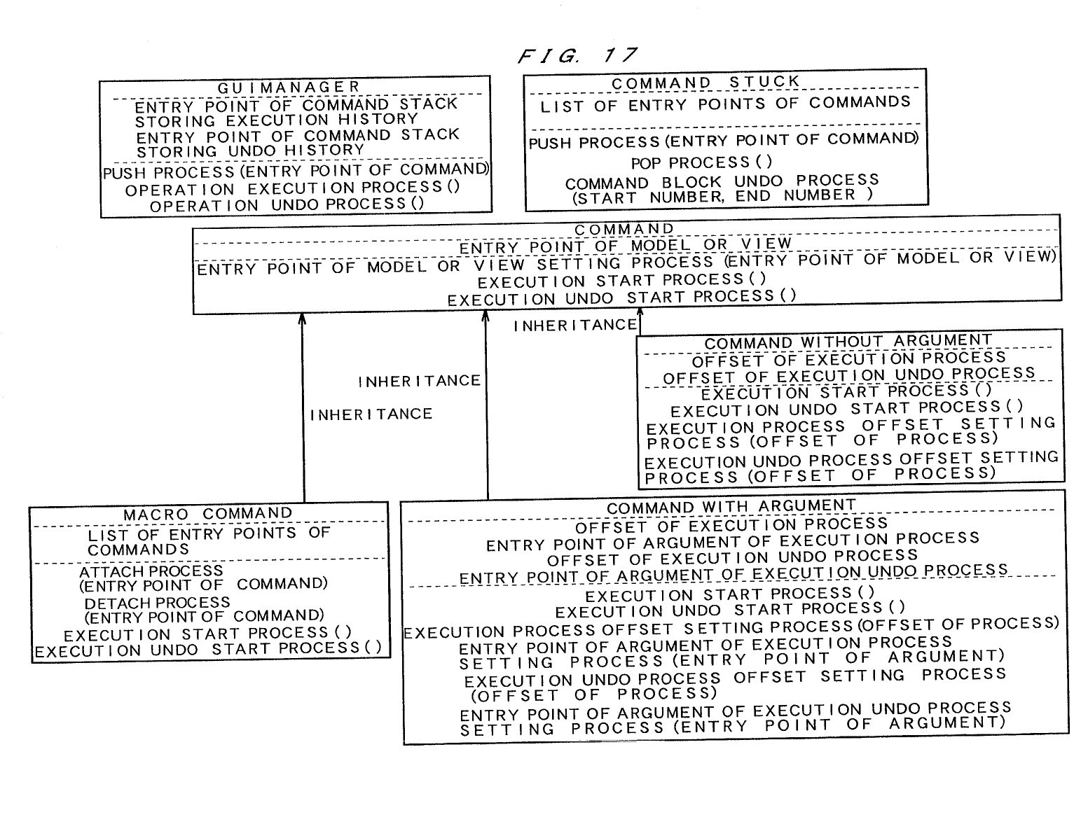

The GUI generating/managing section 34 comprises model view controller command means, command execution history stack means, operation undo means, command undo history stack means and operation redo means. FIGS. 16 and 17 are block diagrams of a primary object of a GUI generating/managing section 34 corresponding to embodiment 2. Here, FIGS. 16 and 17 together show the configuration of primary object of the GUI generating/managing section 34. The feature of each object and object(s) for cooperation are described in the following.

“Observer”:

It is similar to the “observer” of embodiment 1 described above, and detailed description of it is omitted.

“Model”:

[Feature]

It provides core functions of an application. It registers a dependent view and controller. It informs the dependent view and controller of modification of data.

[Object for Cooperation]: View, Controller

[Attribute]

Setting entry point of observer

An entry point of observer is address data of an observer on the memory 26. Setting an entry point is to have an entry point in an array structure.

[Process]

Attach process (entry point of observer)

The attach process registers an observer provided by an argument in an ‘setting entry point of observer’ attribute.

Detach process (entry point of observer)

The detach process deletes an observer provided by an argument from an ‘setting entry point of observer’ attribute.

Informing process ( )

The informing process is a process for executing the ‘update process’ of an observer. A subject on which the process is executed is an observer stored on the memory 26 as a ‘setting entry point of observer’ attribute.

Service process ( )

It is a service process provided by a model. Detail of process depends on a child object.

Service undo process ( )

It is a process for undoing a service provided by a model. Detail of process depends on a child object.

“View”:

[Feature]

It implements the update process. It generates a relevant controller.

[Object for Cooperation]: Controller, Model

[Attribute]

Entry point of model

It is a region for storing an entry point of a model on the memory 26.

Entry point of controller

It is a region for storing an entry point of a controller operating in pair of a view on the memory 26.

Display coordinates

The display coordinates are a region for storing positional coordinates (x, y) on the graphics display for displaying an image. The positional coordinates on the graphics display agree with the coordinates for the display region of the video RAM 12.

Video RAM region

The video RAM region is a region for storing an entry point and size of an image produced in the non-display region of the video RAM.

Foreground color

The foreground color is a region for storing the color of an image in RGB values.

Background color

The background color is a region for storing the background color of an image in RGB values.

Button-down receiving flag

The button-down receiving flag is integer type data. The button-down receiving flag becomes 1 when allowing button-down, and 0 when not allowing button-down.

Button-up receiving flag

The button-up receiving flag is integer type data. The button-up receiving flag becomes 1 when allowing button-up, and 0 when not allowing button-up.

Drag receiving flag

The drag receiving flag is integer type data. The drag receiving flag becomes 1 when allowing dragging, and 0 when not allowing dragging.

[Process]

Initializing process ( )

It is a process for clearing an attribute, and executing an ‘image generating process’ and a ‘controller generating process.’

Image generating process ( )

It is a process for generating an image in the non-display region of the video RAM 12 in pixel values. The ‘image generating process’ references the lookup table 20, and obtains pixel values corresponding to color of a GUI image to be produced. If the lookup table 20 does not contain corresponding color information, a view establishes new color values in empty entries of the lookup table 20, and obtains these pixel values. Then, the ‘image generating process’ generates an icon image in a continuous non-display region in the video RAM 12 based on the obtained pixel values. Then, this region is stored on the memory 26 as a ‘video RAM region’ attribute. An image to be produced depends on a child object.

Controller generating process ( )

It is a process for generating a controller which starts a relevant command, and executing the ‘initializing process’ of the controller.

Update process ( )

It is a process for executing the ‘display process.’

Display process ( )

It is a process for transferring an image in the non-display region of the video RAM 12 indicated by the ‘video RAM region’attribute to the display region of the video RAM 12.

Video RAM region obtaining process ( )

It is a process for reading a value stored on the memory 26 as the ‘video RAM region’ attribute.

Video RAM region setting process (entry point on video RAM 12, size of image)

It is a process for setting a value of argument in the ‘video RAM region’ attribute.

Display coordinates obtaining process ( )

It is a process for reading a ‘display coordinates’ attribute.

Display coordinates setting process (positional coordinates)

It is a process for setting a value of argument in the ‘display coordinates’ attribute.

Movement process ( ) (positional coordinates)

It stores positional coordinates provided by an argument in the ‘display coordinates’ attribute. Then, it implements the ‘update process.’

“Controller”:

[Feature]

It receives an event input by the user. It converts an event into an execution process start request for a command. It implements the update process. It generates a copy of a command when the command execution start process is started, and registers it in the GUI manager.

[Object for Cooperation]

View, model, command, GUI manager

[Attribute]

Entry point of model

It is a region for storing an entry point of a model on the memory 26.

Entry point of view

It is a region for storing an entry point of a view on the memory 26.

Button-down process execution flag

The button-down event process execution flag is integer type data. It becomes 1 when allowing the button-down process, and 0 when not allowing it.

Button-up process execution flag

The button-up event process execution flag is integer type data. It becomes 1 when allowing the button-up process, and 0 when not allowing it.

Drag process execution flag

The drag process execution flag is integer type data. It becomes 1 when allowing the drag process, and 0 when not allowing it.

Entry point of button-down process command

It stores an entry point on the memory 26 of a command for starting the execution process at the completion of button-down.

Entry point of button-up process command

It stores an entry point on the memory 26 of a command for starting the execution process at the completion of button-up.

Entry point of drag process command

It stores an entry point on the memory 26 of a command for starting the execution process at the completion of drag.

[Process]

Update process ( )

It sets the ‘button-down receiving flag,’ ‘button-up receiving flag’ and ‘drag receiving flag’ attributes of the view indicated by the ‘entry point of view’ attribute in the ‘button-down process execution flag,’ ‘button-up process execution flag’ and ‘drag process execution flag’ attributes.

Initializing process (entry point of view)

It stores the entry point of view specified by an argument in the ‘entry point of view’ attribute.

Button-down completion process (positional coordinates)

It performs the ‘execution start process’ of a command specified in the ‘entry point of button-down process command’ attribute. This process runs only when the ‘button-down process execution flag’ attribute is 1. When the ‘execution start process’ of the command is performed, it generates a copy of the performed command on the memory 26. Then, it performs the ‘push process’ of the GUI manager with the entry point of the generated copy as an argument. The entry point of GUI manager is obtained by utilizing the object detecting section 44.

Button-up completion process (positional coordinates)

It performs the ‘execution start process’ of a command specified in the ‘entry point of button-up process command’ attribute. This process runs only when the ‘button-up process execution flag’ attribute is 1. When the ‘execution start process’ of the command is performed, it generates a copy of the performed command on the memory 26. Then, it performs the ‘push process’ of the GUI manager with the entry point of the generated copy as an argument. The entry point of GUI manager is obtained by utilizing the object detecting section 44.

Drag process (positional coordinates)

It is a process during the pointing device 30 is being dragged. This process runs only when the ‘drag process execution flag’ attribute is 1.

Drag completion process (positional coordinates)

It performs the ‘execution start process’ of a command specified in the ‘entry point of drag process command’ attribute. This process runs only when the ‘drag process execution flag’ attribute is 1. When the ‘execution start process’ of the command is performed, it generates a copy of the performed command on the memory 26. Then, it performs the ‘push process’ of the GUI manager with the entry point of the generated copy as an argument. The entry point of GUI manager is obtained by utilizing the object detecting section 44.

Entry point of button-down process command setting process (entry point of command)

It stores the entry point of a command specified by an argument in the ‘entry point of button-down process command’ attribute.

Entry point of button-up process command setting process (entry point of command)

It stores the entry point of a command specified by an argument in the ‘entry point of button-up process command’ attribute.

Entry point of drag process command setting process (entry point of command)

It stores the entry point of a command specified by an argument in the ‘entry point of drag process command’ attribute.

“Command”:

[Feature]

It defines an attribute and a process common to a child object of a command.

[Object for Cooperation]: Model, View, Controller

[Attribute]

Entry point of model or view

It is a region for storing an entry point of a model or view on the memory 26.

[Process]

Entry point of model or view setting process (entry point of model or view)

It is a process for setting an entry point of a model or view provided by an argument in the ‘entry point of model or view’ attribute.

Execution start process ( )

The ‘execution start process’ of command does nothing. It is a process prepared so that the ‘execution start process’ of the child object of the command can be executed.

Execution undo start process ( )

The ‘execution undo start process’ of command does nothing. It is a process prepared so that the ‘execution undo start process’ of the child object of the command can be executed.

“Command without argument”

[Feature]

It is implemented that the execution start process starts a process without an argument of model or view. It is implemented that the execution undo start process starts a process without an argument of model or view.

[Object for Cooperation]: Model, View, Controller

[Attribute]

Offset of execution process

It is a region for storing an offset value of address on the memory 26 from an entry point of object to an entry point of the execution process.

Offset of execution undo process

It is a region for storing an offset value of address on the memory 26 from an entry point of object to an entry point of the execution undo process.

[Process]

Execution start process ( )

It executes the execution process of an object specified in the ‘entry point of model or view’ attribute. The process to be executed is a process set in the ‘offset of execution process’ attribute.

Execution undo start process ( )

It executes the execution undo process of an object specified in the ‘entry point of model or view’ attribute. The process to be executed is a process set in the ‘offset of execution undo process’ attribute.

Execution process offset setting process (offset of process)

It sets an offset of process provided by an argument in the ‘offset of execution process’ attribute.

Execution undo process offset setting process (offset of process)

It sets an offset of process provided by an argument in the ‘offset of execution undo process’ attribute.

“Command with argument”

[Feature]

It is implemented that the execution start process starts a process with an argument of model or view. It is implemented that the execution undo start process starts a process with an argument of model or view.

[Object for Cooperation]: Model, View, Controller

[Attribute]

Offset of execution process

It is a region for storing an offset value of address on the memory 26 from an entry point of object to an entry point of the execution process.

Entry point of argument of execution process

It stores an entry point of an argument specified when executing the execution process.

Offset of execution undo process

It is a region for storing an offset value of address on the memory 26 from an entry point of object to an entry point of the execution undo process.

Entry point of argument of execution undo process

It stores an entry point of an argument specified when executing the execution undo process.

[Process]

Execution start process ( )

It executes a process with an argument of object specified in the ‘entry point of model or view’ attribute. The process to be executed is a process set in the ‘offset of execution process’ attribute. The argument utilized in this case is provided by the ‘entry point of argument of execution process’ attribute.

Execution undo start process ( )

It executes the process with argument of model or view. The process to be executed is a process set in the ‘offset of execution undo process’ attribute. The argument utilized in this case is provided by the ‘entry point of argument of execution undo process’ attribute.

Execution process offset setting process (offset of process)

It sets the ‘offset of process’ provided by the argument in the ‘offset of execution process’ attribute.

Entry point of argument of execution process setting process (entry point of argument)

It sets an entry point provided by the argument in the ‘entry point of argument of execution process’ attribute.

Execution undo process offset setting process (offset of process)

It sets an ‘offset of process’ provided by an argument in the ‘offset of execution undo process’ attribute.

Entry point of argument of execution undo process setting process (entry point of argument)

It sets an entry point provided by the argument in the ‘entry point of argument of execution undo process’ attribute.

“Macro command”:

[Feature]

It is an object combining commands. The execution start process performs the execution start process of commands in an order of registration. The execution undo start process performs the execution undo start process of commands in a reverse order of registration.

[Object for Cooperation]: Controller, Command

[Attribute]

List of entry points of commands

It is an array data of entry points of commands. It stores the entry points of command in an order.

[Process]

Attach process (entry point of command)

It is a process for registering an entry point of a command provided by an argument at the end of the ‘list of entry points of commands’ attribute.

Detach process (entry point of command)

It is a process for deleting an entry point of a command provided by an argument from the ‘list of entry points of commands’ attribute.

Execution start process ( )

It performs the ‘execution start process’ of a command in an order registered in the ‘list of entry points of commands’ attribute.

Execution undo start process ( )

It performs the ‘execution undo start process’ of a command in a reverse order registered in the ‘list of entry points of commands’ attribute.

“Command stack”:

[Feature]: It Stores a Command in the Memory 26

[Object for Cooperation]: GUI Manager

[Attribute]

List of entry points of commands

It is an array data of entry points of commands.

[Process]

Push process (entry point of command)

It is a process for registering an entry point of a command provided by an argument at the end of the ‘list of entry points of commands’ attribute.

Pop process ( )

It fetches the entry point of a command registered at the end of the ‘list of entry points of commands’ attribute. The fetched entry point of command is deleted from the ‘list of entry points of execution commands’ attribute.

Command block obtaining process (start number, end number)

Both the start and end numbers of argument are integer type data. It is a process for reading array data of entry points of commands from the start number to the end number provided by the arguments of array data stored with the ‘list of entry points of commands.’

Operation redo process ( )

The ‘operation redo process’ acquires a command registered at the end of the ‘list of entry points of undo commands’ attribute. Then, it deletes a command registered at the obtains end of the ‘list of entry points of undo commands’ attribute. The acquired command is registered at the end of ‘list of entry points of execution commands’ attribute with the ‘push process.’ Finally, the ‘execution start process’ is performed for the fetched command.

“GUI manager”:

[Feature]

It is an object for saving the execution history and the undo history of a command. The GUI manager is generated at starting the system.

[Object for Cooperation]: Command Stack

[Attribute]

Entry point of command stack storing execution history

It is a region for storing a command stack for saving a command on which the execution start process is performed by the GUI operation in the memory. When the GUI manager is generated, a command stack is generated for storing the execution history. Then, an entry point of the generated command stack is stored in this attribute.

Entry point of command stack storing undo history

It is a region for storing a command stack for saving a command on which the execution undo start process is performed by the GUI operation in the memory 26. When the GUI manager is generated, a command stack is generated for storing the undo history the entry point of which is stored in this attribute.

[Process]

Push process (entry point of command)

It is a process for executing the ‘push process’ of a command stack which is registered in the ‘entry point of command stack storing execution history’ attribute with the entry point of command provided by the argument as an argument.

Operation undo process ( )

The operation undo process first executes the ‘pop process’ of command stack registered in the ‘entry point of command stack storing execution history’ attribute. Then, it specifies the entry point of command obtained by the ‘pop process’ as an argument, and executes the ‘push process’ of command stack registered in the ‘entry point of command stack storing undo history’ attribute. Finally, it executes the ‘execution undo start process’ of the command obtained by the ‘pop process.’

Operation redo process ( )

The operation redo process first executes the ‘pop process’ of command stack registered in the ‘entry point of command stack storing undo history’ attribute. Then, it executes the ‘push process’ by specifying the entry point of command obtained by the ‘pop process’ as an argument. Finally, it executes the ‘execution start process’ of the command obtained by the ‘pop process.’

Now, description is given GUI operation undo and redo process by the GUI generating/managing section 34 combining the model view controller command means, the command execution history stack means, the operation undo means, the command undo history stack means and the operation redo means. In this example, it is assumed that an image of view is moved by button-up of the pointing device 30 with push button to execute the service process of model. In addition, it is also assumed that the model, view and controller to be operated have been built.

(1) Generation of command

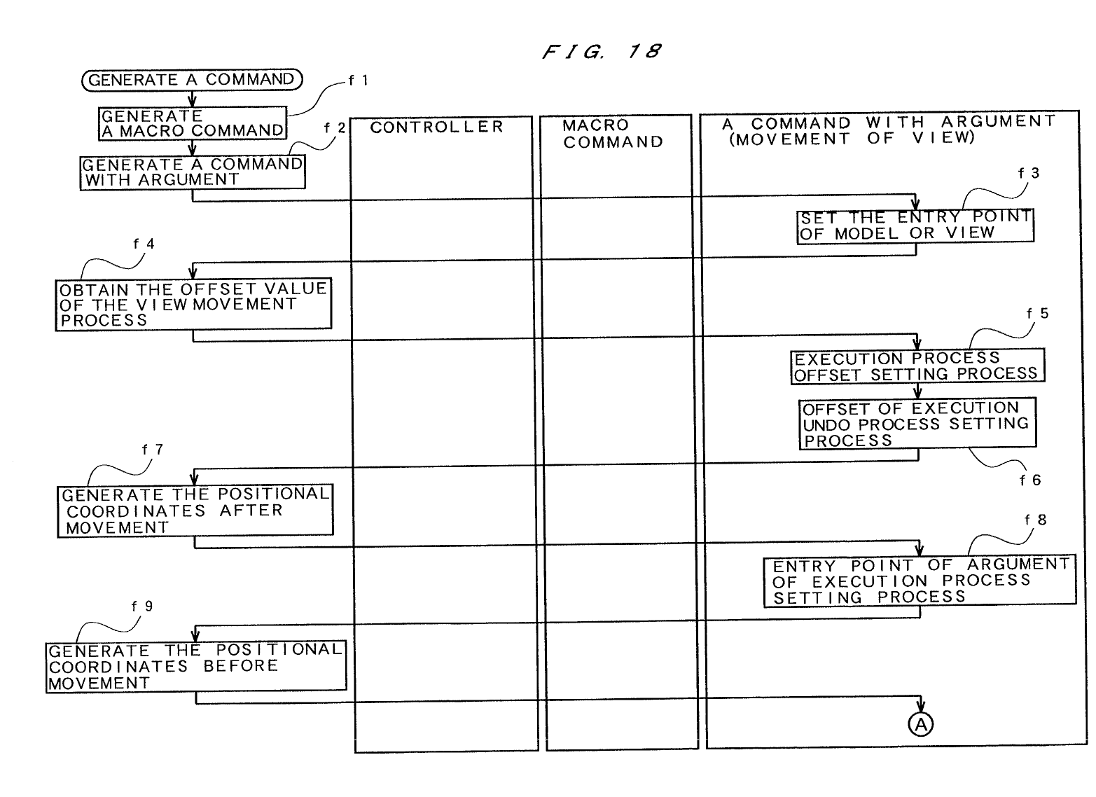

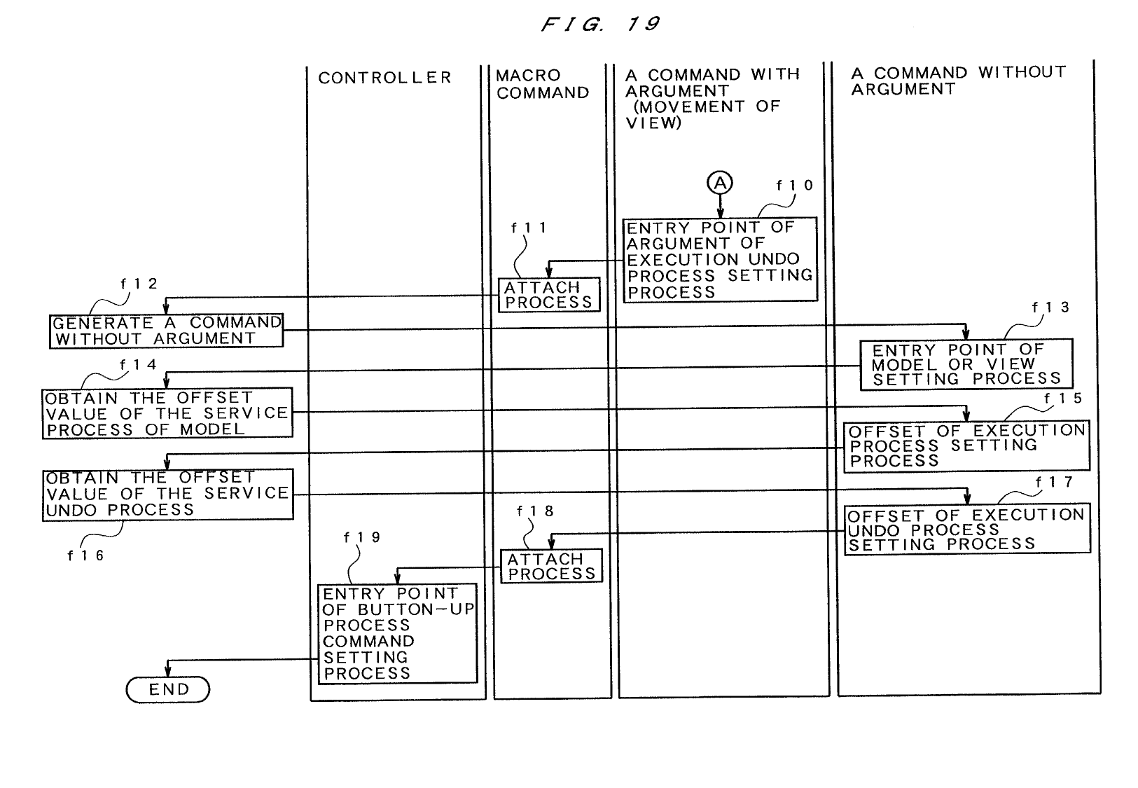

FIGS. 18 and 19 are a flowchart showing a procedure for command generation process by the object generating/managing section 34.

First, a macro command is generated (step f1) to generate a “command with argument” necessary to move the view (step f2). In this ‘command with argument,’ the ‘entry point of model or view setting process’ is performed (step f3). The entry point of view is given as the argument in executing the setting process. In addition, set in the entry point of model or view setting process is the entry point of view provided in the ‘entry point of model or view’ attribute by the argument.

Then, the offset value of the view movement process is calculated (step f4). The offset value of the view movement process is a difference from the entry point of view object to the entry point in which the view movement process is stored.

After the offset value of the view movement process is calculated, the command with argument performs the ‘execution process offset setting process’ (step f5). An argument specified in this case is the offset value obtained in step f4. The ‘execution process offset setting’ sets the offset provided by the argument in the ‘offset of execution process’ attribute. In addition, the command with argument performs the ‘offset of execution undo process setting process’ (step f6). An argument specified in this case is the offset value obtained in step f4. The ‘offset of execution undo process setting process’ set the offset provided by the argument in the ‘offset of execution undo process’ attribute.

Then, positional coordinates which move at button-up are generated (step f7), and the generated positional coordinates are written in the memory 26. Then, the command with argument performs the ‘entry point of argument of execution process setting process’ (step f8). An argument specified in this case is the entry point stored in the memory 26 in step f7.

Moreover, positional coordinates before movement are generated (step f9), and written in the memory 26. Then, the command with argument performs the ‘entry point of argument of execution undo process setting process’ (step f10). An argument specified in this case is the entry point stored in the memory 26 in step f9. Moreover, the ‘attach process’ is performed by the above macro command generated in step f1 (step f11). Then, the generated command with argument is stored in the ‘list of entry points of commands’ attribute.

As such, a series of processes using the ‘command with argument’ necessary in moving the view are performed, and there are performed processes including generation of “command without argument” necessary for starting the service process of model and processes accompanied thereto.

First, a command without argument necessary for starting the service process of model is generated (step f12). Then, the generated command without argument performs the ‘entry point of model or view setting process’ (step f13). The entry point of model is given as the argument in executing the setting process.

Then, the offset value of the service process of model is calculated (step f14). In addition, the command without argument performs the ‘offset of execution process setting process’ (step f15). An argument specified in this case is the offset value obtained in step f14.

Moreover, the offset value is calculated for the service undo process of model (step f16), and the command without argument performs the ‘offset of execution undo process setting process’ (step f17). An argument specified in this case is the offset value obtained in step f16. Moreover, the ‘attach process’ of the macro command generated in step f1 described above is executed (step f18), and the generated command without argument is stored in the ‘list of entry points of commands’ attribute of the macro command.

Then, the controller performs the ‘entry point of button-up process command setting process’ (step f19). An argument specified in this case is the entry point of the macro command generated in step f1.

(2) Starting execution start process of command with button-up process of view

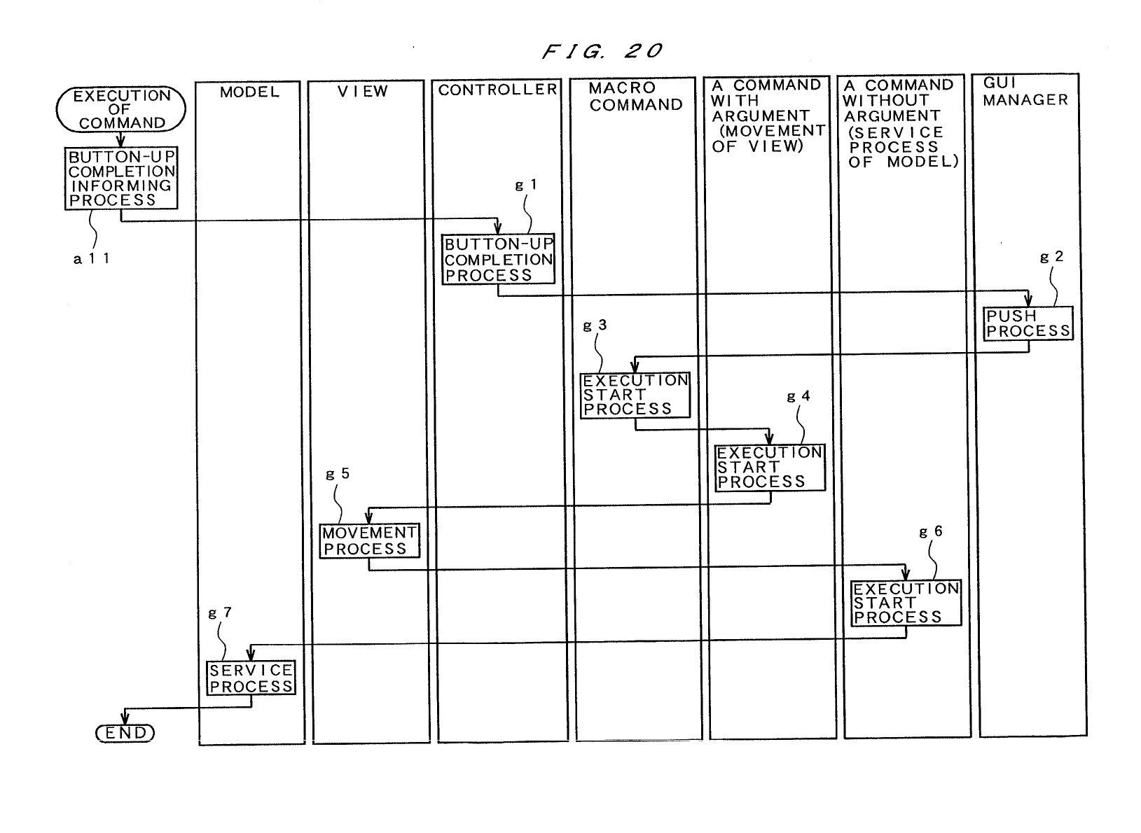

FIG. 20 is a flowchart showing a procedure for command execution start process by the object generating/managing section 34.

Step all is the ‘button-up completion informing process’ contained in the operation procedure shown in FIG. 8. When the ‘button-up completion informing process’ is performed, the controller performs the ‘button-up completion process’ (step g1). The ‘button-up completion process’ of the controller references the ‘entry point of button-up process command’ attribute to generate a copy of the button-up process command on the memory 26. Then, it performs the ‘push process’ of the GUI manager with the entry point of the generated copy as an argument (step g2).

In addition, the ‘button-up completion process’ of the controller performs the ‘execution start process’ with the macro command stored in the ‘entry point of button-up process command’ attribute (step g3).

The ‘execution start process’ of the macro command performs the ‘execution start process’ with the command in the order of registration in the ‘list of entry points of commands’ attribute. In this example, registration is made in the ‘list of entry points of commands’ attribute in the order of the ‘command with argument’ for moving the view, and the ‘command without argument’ for performing the service process of model.

First, the ‘execution start process’ of macro command performs the ‘execution start process’ with the ‘command with argument’ (step g4). The ‘execution start process’ with the ‘command with argument’ references the attribute to perform the movement of view process of step g5.

Then, the ‘execution start process’ of macro command performs the ‘execution start process’ with the ‘command without argument’ (step g6). The ‘execution start process’ with the ‘command without argument’ references the attribute to perform the ‘service process’ of model of step g7.

(3) Undo of GUI operation

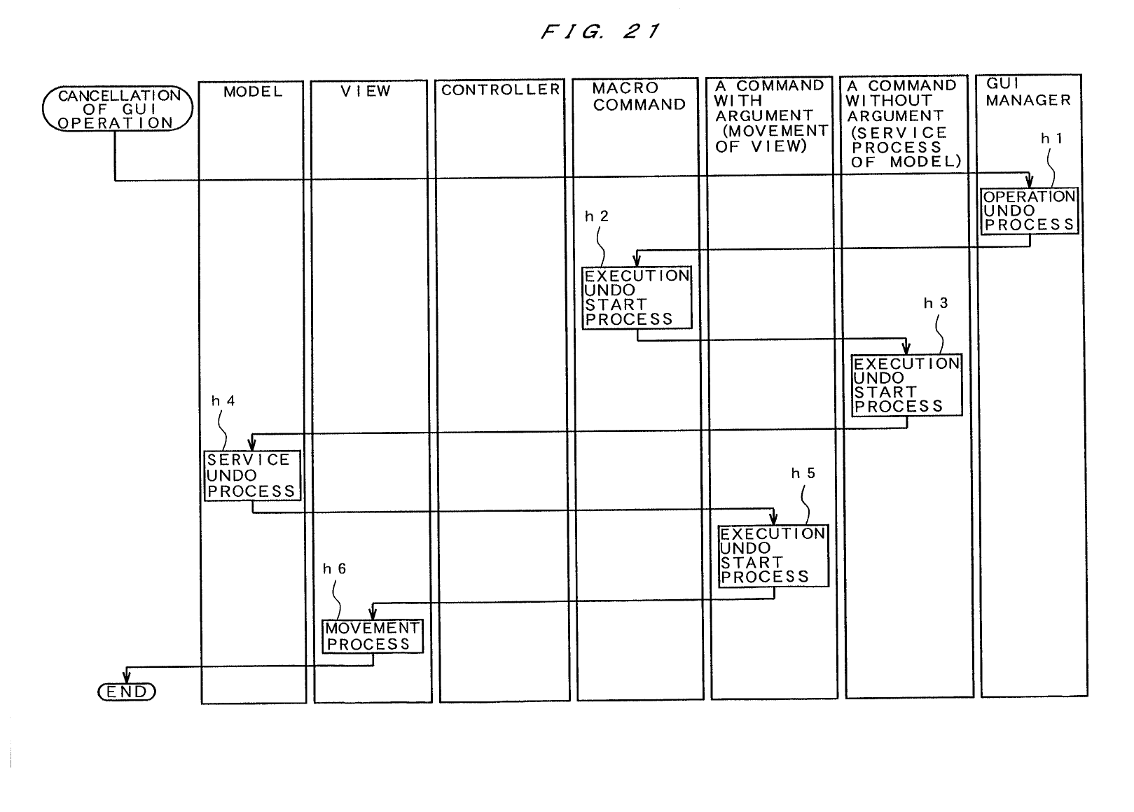

FIG. 21 is a flowchart showing a procedure for GUI operation undo process by the object generating/managing section 34.

Cancellation of GUI operation is attained by executing the ‘operation undo process’ with the GUI manager (step h1). The ‘operation undo process’ of the GUI manager first executes the ‘pop process’ with the command stack registered in the ‘entry point of command stack storing execution history’ attribute. In this example, a macro command is obtained. Then, the ‘operation undo process’ of the GUI manager performs the ‘push process’ with the command stack registered in the ‘entry point of command stack storing execution history’ attribute by specifying the entry point of the obtained command as an argument. Finally, the ‘operation undo process’ of the GUI manager performs the ‘execution undo start process’ with the obtained macro command (step h2).

The ‘execution undo start process’ of the macro command performs the commands in a reverse order of registration in the ‘list of entry points of commands’ attribute. In this example, registration is made in the ‘list of entry points of commands’ attribute in the order of the ‘command with argument’ for moving the view, and the ‘command without argument’ for performing the service process of model.

First, the ‘execution undo start process’ of macro command performs the ‘execution undo start process’ with the ‘command without argument’ (step h3). The ‘execution undo start process’ with the ‘command without argument’ references the attribute to perform the ‘service undo process’ with a model (step h4).

Then, the ‘execution undo start process’ of macro command performs the ‘execution undo start process’ with the ‘command with argument’ (step h5). The ‘execution start process’ with the ‘command with argument’ references the attribute to perform the ‘movement process’ with a view (step h6).

(4) Redo of GUI operation

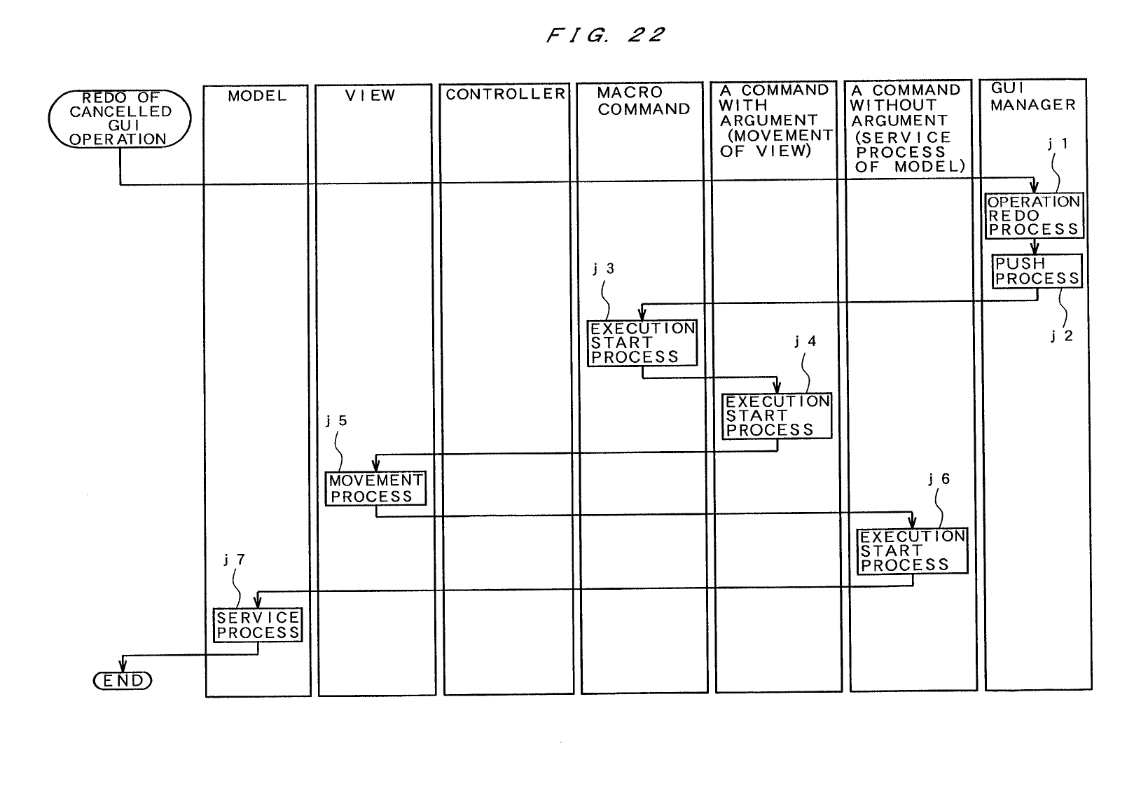

FIG. 22 is a flowchart showing a procedure for GUI operation redo process by the object generating/managing section 34.

Redo of cancelled GUI operation is attained by executing the ‘operation redo process’ with the GUI manager (step j1). The ‘operation redo process’ of the GUI manager first executes the ‘pop process’ with the command stack registered in the ‘entry point of command stack storing undo history’ attribute. Then, the GUI manager performs the ‘push process’ by specifying the entry point of the obtained command as an argument (step j2). Finally, the command obtained by the ‘pop process’ performs the ‘execution start process.’ In this example, a macro command is obtained, and the macro command performs the ‘execution start process’ (step j3).

The ‘execution start process’ of macro command performs the ‘execution start process’ of the command in the order of registration in the ‘list of entry points of commands’ attribute. In this example, registration is made in the ‘list of entry points of commands’ attribute in the order of the ‘command with argument’ for moving the view, and the ‘command without argument’ for performing the service process of model.

First, the ‘execution start process’ of macro command performs the ‘execution start process’ with the ‘command with argument’ (step j4). The ‘execution start process’ with the ‘command with argument’ references the attribute to perform the ‘movement process’ with a view (step j5).

Then, the ‘execution start process’ of macro command performs the ‘execution start process’ with the ‘command without argument’ (step j6). The ‘execution start process’ with the ‘command without argument’ references the attribute to perform the ‘service process’ with model (step j7).

As described the automatic demonstration function can be attained by previously storing commands to be demonstrated in a macro command, and performing the ‘execution start process’ with the macro command.

[Embodiment 3]

Embodiment 3 corresponds to a case where the GUI generating/managing section 34 is provided with functions of model view controller command means, command execution history stack means, operation undo means, command undo history stack means, operation redo means, drag controller means, command block execution means and command block edit means, and illustrates a method for implementing generation and edit of a automatic demonstration sequence of GUI operation utilizing a block of command generated through execution or undo of operations.

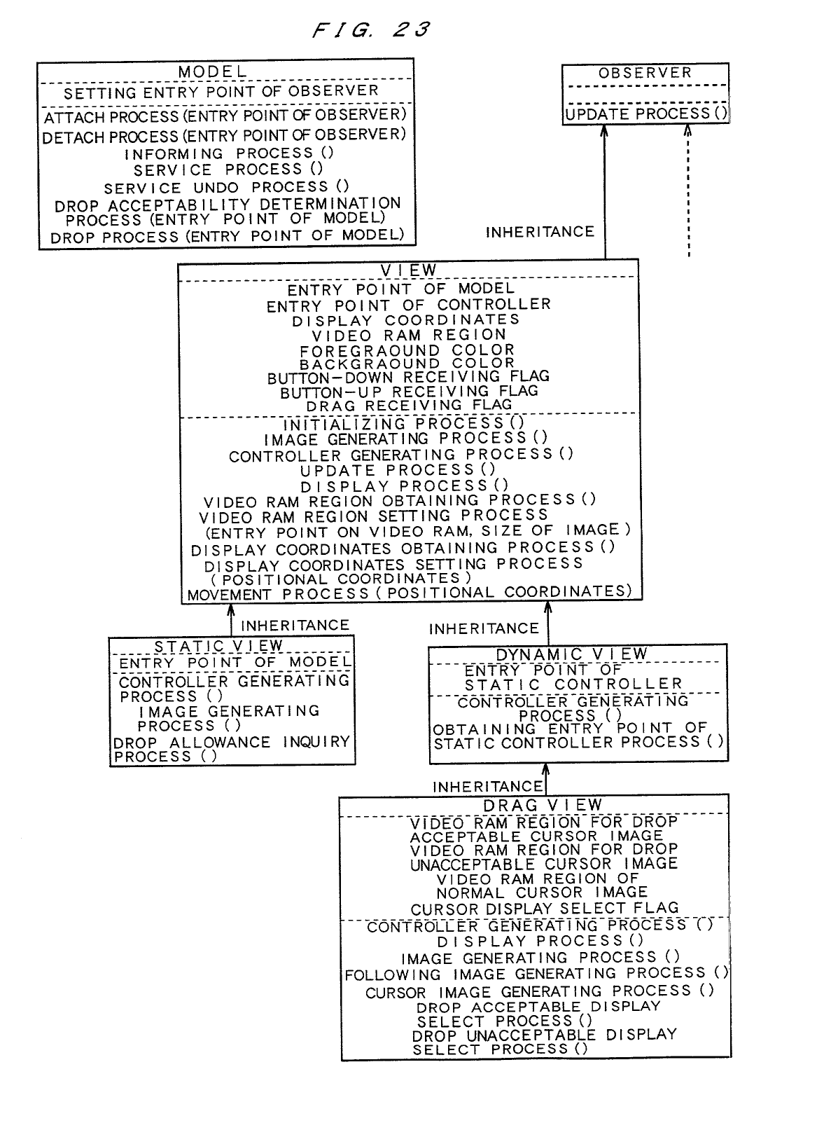

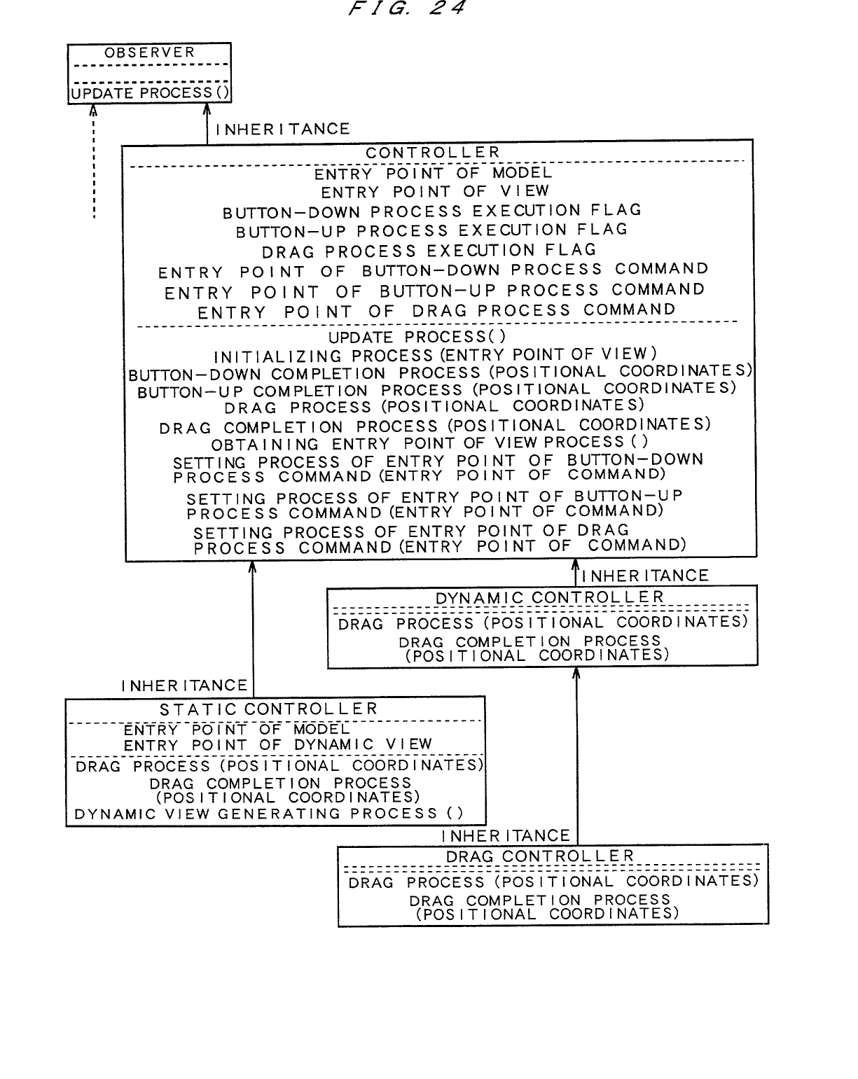

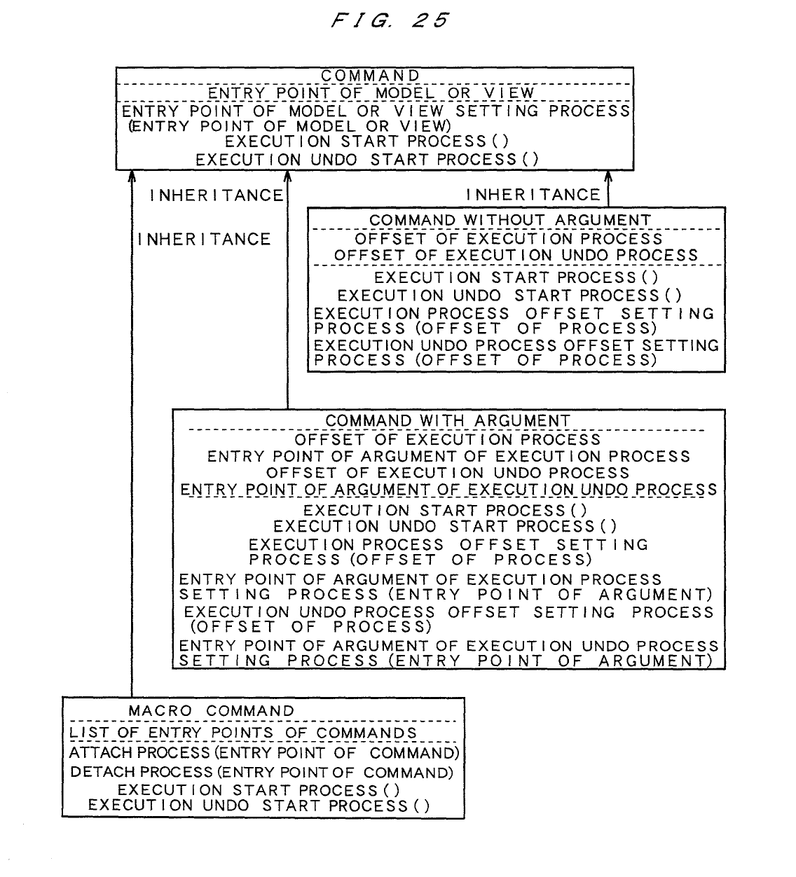

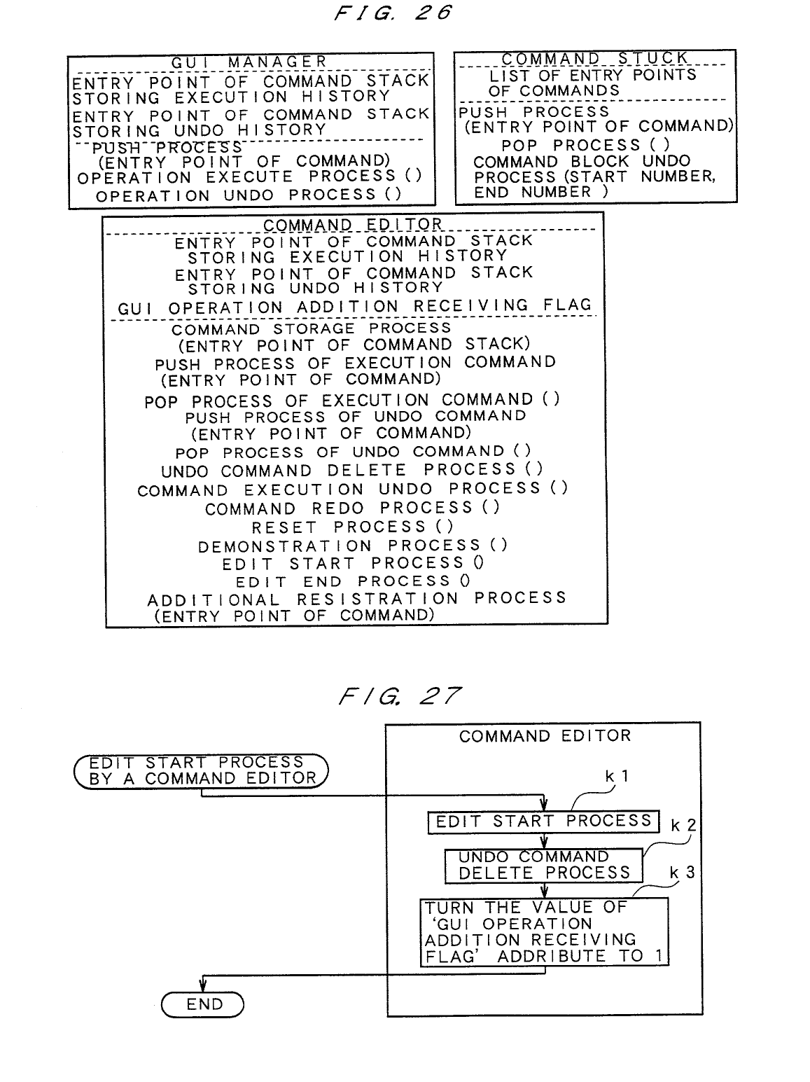

The GUI generating/managing means 34 comprises model view controller command means, command execution history stack means, operation undo means, command undo history stack means, operation redo means, drag controller means, command block execution means and command block edit means. FIGS. 23 through 26 are block diagrams of the primary object of the GUI generating/managing section 34 corresponding to embodiment 3. Here, an “observer” commonly shown in FIGS. 23 and 24 represents the same one. FIGS. 23 through 26 together show a configuration of primary object of the GUI generating/managing section 34. The feature of each object and object(s) for cooperation are described in the following.

“Observer”:

It is similar to the ‘observer’ of embodiment 1, and detailed description of it is omitted.

“Model”:

[Feature]

It provides core functions of an application. It stores a dependent view and controller on the memory 26 as an attribute. It informs the dependent view and controller of modification of data. It accommodates an inquiry on whether or not a drop request is accepted.

[Object for Cooperation]: View, Controller, Command

[Attribute]

Setting entry point of observer

An entry point of observer is address data of an observer on the memory. Setting an entry point is to have an entry point in an array structure.

[Process]

Attach process (entry point of observer)

The attach process registers an observer provided by an argument in a ‘setting entry point of observer’ attribute.

Detach process (entry point of observer)

The detach process deletes an observer provided by an argument from an ‘setting entry point of observer’ attribute.

Informing process ( )

The informing process is a process for executing the ‘update process’ of an observer. A subject on which the process is executed is an observer stored on the memory 26 as a ‘setting entry point of observer’ attribute.

Drop acceptability determination process (entry point of model)

The drop acceptability determination process is a process for determining whether or not a model provided by an argument can be dropped.

Drop process (entry point of model)

It is a process when an icon is dropped by drag and drop of the icon on a view depending on a model. A model of the dropped icon is specified as an argument. Detail of process depends on a child object.

Service process ( )

It is a service process provided by a model. Detail of process depends on a child object.

Service undo process ( )

It is a process for undoing a service provided by a model. Detail of process depends on a child object.

The “view,” “static view,” “dynamic view,” “drag view,” “dynamic controller,” and “drag controller” are all same as those described for embodiment 1, and detailed description of them is omitted.

Similarly, the “controller starting command,” “static controller,” “command,” “command without argument,” “command with argument,” “macro command,” and “command stack” are all same as those described for embodiment 2, and detailed description of them is omitted.

“GUI manager”:

[Feature]

It is an object for saving the execution history and the undo history of a command. The GUI manager is generated at starting the system.

[Object for Cooperation]: Command, Stack, Command Editor

[Attribute]

Entry point of command stack storing execution history

It is a region for storing a command stack for saving a command on which the execution start process is performed by the GUI operation in the memory. When the GUI manager is generated, a command stack is generated for storing the execution history. Then, an entry point of the generated command stack is stored in this attribute.

Entry point of command stack storing undo history

It is a region for storing a command stack for saving a command on which the execution undo start process is performed by the GUI operation in the memory 26. When the GUI manager is generated, a command stack is generated for storing the undo history. An entry point of the generated command stack is stored in this attribute.

[Process]

Push process (entry point of command)

It is a process for executing the ‘push process’ which is registered in the ‘entry point of command stack storing execution history’ attribute with the entry point of command provided by the argument as an argument. In addition, it executes an ‘additional registration process’ of the command editor with the entry point of command provided by an argument as an argument.

Operation undo process ( )

The operation undo process first executes the ‘pop process’ of command stack registered in the ‘entry point of command stack storing execution history’ attribute. Then, it specifies the entry point of command obtained as an argument, and executes the ‘push process’ of command stack registered in the ‘entry point of command stacks to ring undo history’ attribute. Finally, it executes the ‘execution undo start process’ of the command obtained by the ‘pop process.’

Operation redo process ( )

The operation redo process first executes the ‘pop process’ of command stack registered in the ‘entry point of command stack storing undo history’ attribute. Then, it specifies the entry point of command obtained as an argument, and executes the ‘push process’. Finally, it executes the ‘execution start process’ of the command obtained by the ‘pop process.’

“Command editor”:

[Feature]

It stores a command in the memory 26 with the command as an attribute. It can execute an execution start process of commands in the order of storage (demonstration of operation). It can perform step execution of commands stored in the memory 26 as an attribute. It can delete commands after a command stored in the memory 26 as an attribute, and add a new command.

[Object for Cooperation] Command Stack, GUI Manager

[Attribute]

Entry point of command stack storing execution history

It is a region for storing a command stack for saving a command on which the execution start process is performed by the GUI operation in the memory 26. When the command editor is generated, a command stack is generated for storing an execution history. Then, an entry point of the generated command stack is stored in this attribute.

Entry point of command stack storing undo history

It is a region for storing a command stack for saving a command on which the execution undo start process is performed in the memory 26. When the command editor is generated, a command stack is generated for storing an undo history. Then, an entry point of the generated command stack is stored in this attribute.

GUI operation addition receiving flag

The GUI operation addition receiving flag is integer type data. The GUI operation addition receiving flag becomes 1 when addition of GUI operation is allowed to the command stack registered in the ‘entry point of command stack storing execution history’ attribute, and becomes 0 when the addition of GUI operation is not allowed.

[Process]

Command storage process (entry point of command stack)

The command storage process first copies the content of the command stack indicated by the entry point of command stack provided by an argument in the content of the command stack indicated by the ‘entry point of command stack storing execution history’ attribute. Then, it executes the ‘undo command delete process.’

Push process of execution command (entry point of command)

It is a process for executing the ‘push process’ of a command stack which is registered in the ‘entry point of command stack storing execution history’ attribute with the entry point of command provided by the argument as an argument.

Pop process of execution command ( )

It is a process for executing the ‘pop process’ of a command stack registered in the ‘entry point of command stack storing execution history’ attribute.

Push process of undo command (entry point of command)

It is a process for executing the ‘push process’ of a command stack which is registered in the ‘entry point of command stack storing undo history’ attribute with the entry point of command provided by the argument as an argument.

Pop process of undo command ( )

It is a process for executing the ‘pop process’ of a command stack registered in the ‘entry point of command stack storing undo history’ attribute.

Undo command delete process ( )

It deletes content of the ‘list of entry points of commands’ of command stack indicated by the ‘entry point of command stack storing undo history’ attribute.

C Command execution undo process ( )

The command redo process first executes the ‘pop process of execution command.’ Then, it executes the ‘pop process of undo command’ with the entry point of command obtained by the ‘pop process of execution command’ as an argument. Finally, it executes the ‘execution undo start process’ of the command obtained by the ‘pop process of execution command.’

Command redo process ( )

The command redo process first executes the ‘pop process of undo command.’ Then, it executes the ‘push process of execution command’ with the entry point of command obtained by the ‘pop process of undo command’ as an argument. Finally, it executes the ‘execution start process’ of the command obtained by the ‘pop process of undo command.’

Reset process ( )

It repeatedly executes the ‘command execution undo process’ until the content of the ‘list of entry points of commands’ attribute of command stack registered in the ‘entry point of command stack storing execution history’ attribute becomes empty.

Demonstration process ( )

The demonstration process first executes the ‘reset process.’ Then, it repeatedly executes the ‘command redo process’ until the content of the ‘list of entry points of commands’ attribute of command stack registered in the ‘entry point of command stack storing execution history’ attribute becomes empty.

Edit start process ( )

The edit start process first executes the ‘undo command delete process.’ Then, it turns the value of ‘GUI operation addition receiving flag’ attribute to 1 which allows addition of GUI operation.

Edit end process ( ) It turns the value of ‘GUI operation addition receiving flag’ attribute to 0 which does not allow addition of GUI operation.

Additional registration process (entry point of command)

When the content of ‘GUI operation addition receiving flag’ attribute is 1 which allows addition of GUI operation, it executes the ‘push process of execution command’ with the entry point of command provided by an argument as an argument. When the content of ‘GUI operation addition receiving flag’ attribute is 0 which does not allow addition of GUI operation, it does nothing.

There is attained a drag-and-drop process providing visual feedback, operation undo function, redo function for an undone operation, and automatic demonstration of GUI operation by utilizing these primary objects.

An approach for attaining the drag-and-drop process providing visual feedback is same as that described for embodiment 1. Approaches for attaining the operation undo function, redo function for an undone operation, and automatic demonstration process of GUI operation are basically same as those described for embodiment 2.

Differences from embodiment 1 or 2 lie in that a function is added for editing the content of demonstration with a command editor. In addition, when the command editor is used, the content of demonstration can be created from the content in the command stack which the GUI manager has without previously creating a macro command. Now, detail is described in the following.

(1) Registration of command in command editor

The ‘command storage process’ is executed by the command editor with the ‘entry point of command stack storing execution history’ attribute which the GUI manager has as an argument. Then all GUI operations which have been executed are registered in the command editor as the content of demonstration.

(2) Running of demonstration with command editor

When the ‘demonstration process’ is executed by the command editor, the registered GUI operations by the ‘command storage process’ are reproduced.

(3) Search for changes in application operation with GUI

When the ‘reset process’ is executed by the command editor, all the registered GUI operations by the ‘command storage process’ are deleted. Then, the detail of operation of an application by GUI is reproduced by the ‘command redo process,’ and execution of the ‘command redo process’ by the command editor is repeated until the operation of the application by GUI to be changed is reached. With such process, search can be performed to a GUI image in which detail of the demonstration is changed.

(4) Change of detail of demonstration

(a) Starting change of detail of demonstration

The change is started by executing the ‘edit start process’ with the command editor. FIG. 27 is a diagram showing a procedure for edit start process by a command editor.

The command stack storing the undo history at the moment when the edit start process is executed stores the detail of application operation by GUI after the edit start process is executed. Thus, the edit start process of the command editor (step k1) first executes the undo command delete process (step k2) to delete the content of the command stack in which the undo history is stored. Then, it turns the value of ‘GUI operation addition receiving flag’ attribute to 1 which allows addition of GUI operation (step k3). Then, the commands executed by GUI are stored in the command stack indicated by the ‘entry point of command stack storing execution history’ attribute of the command editor by the ‘additional registration process’ with the command editor. Thus, the content of demonstration is added.

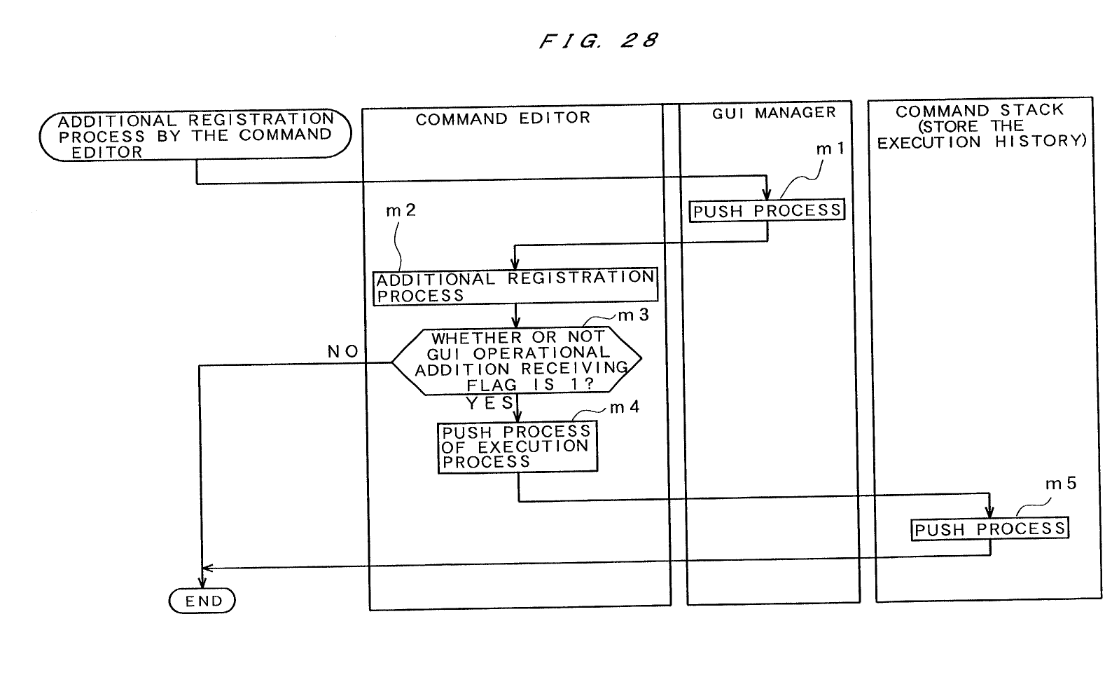

FIG. 28 is a diagram showing a procedure for ‘additional registration process’ by the command editor. When the ‘execution start process’ of command is started by the controller, the GUI manager executes the ‘push process’ (step m1). This ‘push process’ executes the ‘additional registration process’ with the command editor (step m2).

The ‘additional registration process’ of command editor references the ‘GUI operation addition receiving flag’ attribute of the command editor (step m3). When the content of ‘GUI operation addition receiving flag’ attribute is 0 which does not allow addition of GUI operation, it completes the process with doing nothing. In addition, when the content of ‘GUI operation addition receiving flag’ attribute is 1 which allows addition of GUI operation, it executes the ‘push process of execution process’ of the command editor (step m4).

The ‘push process of execution command’ of the command editor executes the ‘push process’ by the command stack storing the execution history, thereby the command for which the ‘execution start process’ is started being stored in the command stack (step m5).

The ‘edit start process’ with the command editor sets the value of ‘GUI operation addition receiving flag’ attribute to 1 which allows addition of a GUI operation. Consequently, the ‘additional registration process’ of the command editor stores the command which executes the ‘execution start process’ in the command stack storing the execution history. Therefore, the content of demonstration of the command editor is added.

(b) Completing change of detail of demonstration

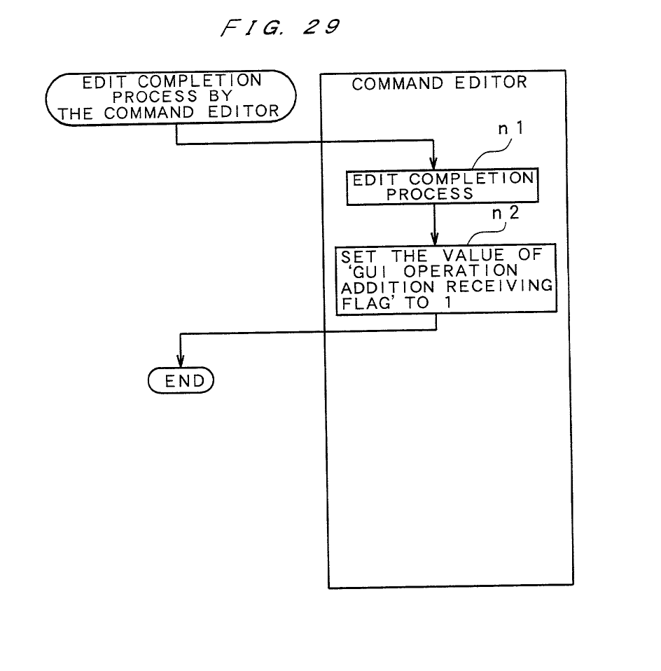

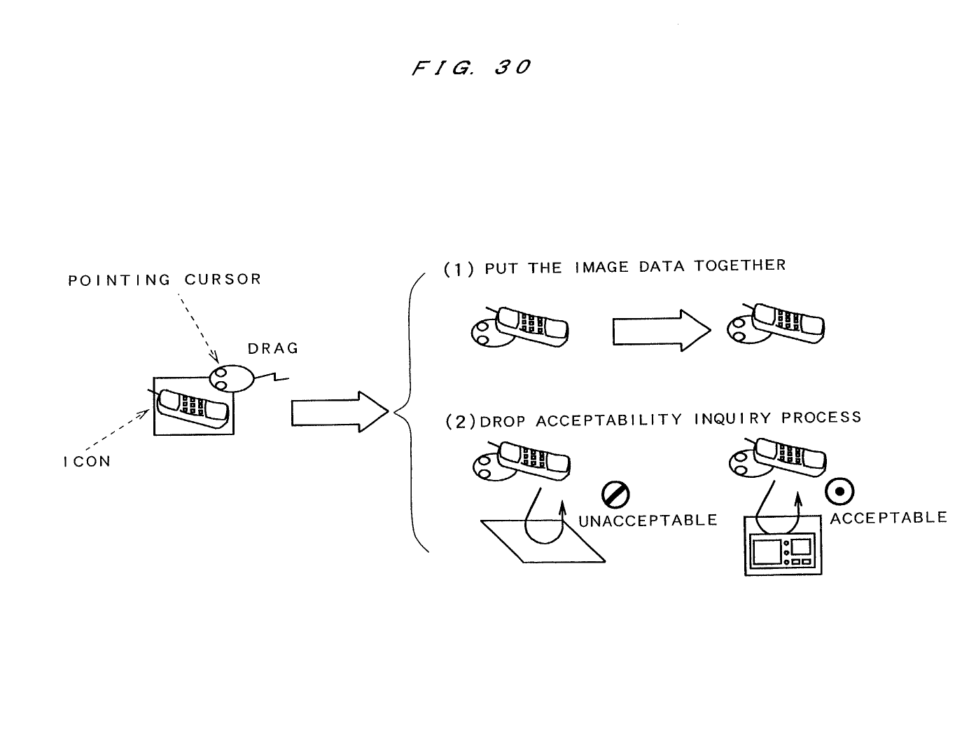

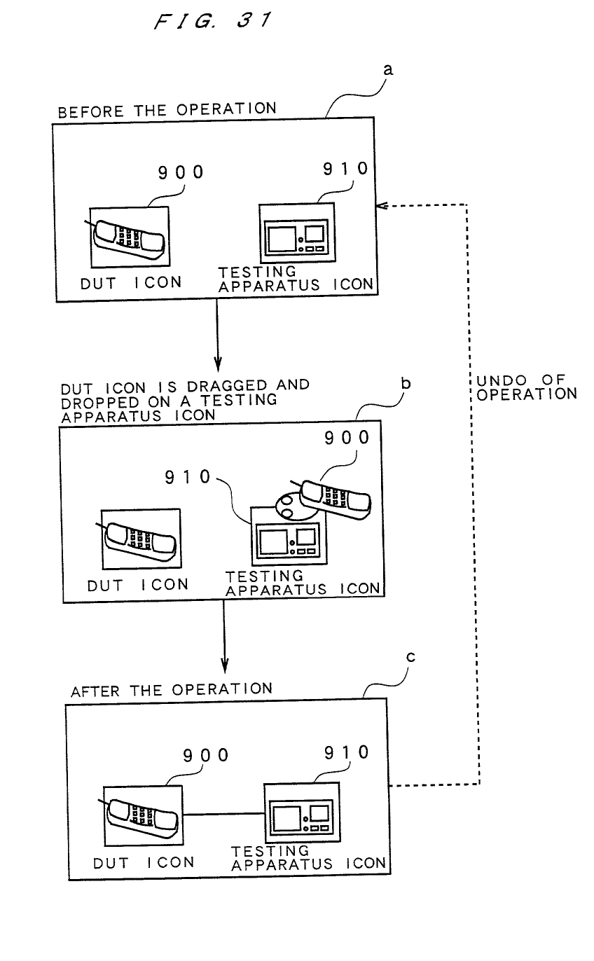

The change is completed by executing the ‘edit completion process’ with the command editor. FIG. 29 is a diagram showing a procedure for edit completion process by a command editor.

When the ‘edit completion process by the command editor is executed (step n1), the value of ‘GUI operation addition receiving flag’ attribute is set to 0 which does not allow addition of GUI operation (step n2). Consequently, the command which executes the ‘execution start process’ is not stored in the command stack storing the execution history of the command editor by the ‘additional registration process’ of the command editor, thereby the content of demonstration being not added.

(5) Demonstration of edited content

The demonstration of edited content is performed by executing the ‘demonstration process’ with the command editor.

As described, the GUI generating/managing section 34 included in the GUI processing section 100 of the testing system according to this embodiment comprises as base objects a “model,” a “view,” a “controller,” a “command,” a “drag controller,” a “command stack,” a “GUI manager,” and a “command editor,” thereby allowing it to attain (1) operation by the drag-and-drop providing visual feedback, (2) cancellation of an application operation with GUI, (3) redoing of undone application operation with GUI, and (4) automatic demonstration of GUI operation.

The present invention is not limited to the embodiments described above, and can be modified within the scope of the present invention. For example, although the testing system is contemplated as one of GUI processing systems in the above embodiments, the present invention may be also applied to another general purpose system performing execution or undo of a predetermined application through drag-and-drop of an icon on the screen.

What is claimed is:

1. A GUI processing system for performing an operation of an application which controls testing equipment for testing a device under test by displaying images such as icons or buttons on a screen, and selecting these images with use of a pointing device, said system comprising GUI generating/managing means, wherein said GUI generating/managing means is a combination of:
a model view controller command means including model means for managing data such as test conditions or test results,
view means for displaying content of said model means on the screen,
command means that has commands corresponding to an execution start process and an execution undo start process of said model means or said view means registered therewith and carries out said execution start process or said execution undo start process that corresponds to any of the commands, and
controller means for detecting an event which is input information from the pointing device, and specifying a command of said commands corresponding to the detected event to activate said execution start process or said execution undo start process that corresponds to the command, and
said command registered with said command means is specified, rather than said controller means directly activating said model means or said view means.

2. The GUI processing system for performing an operation of an application which controls testing equipment as set forth in claim 1, further comprising drag controller means for implementing drag-and-drop providing visual feedback, and wherein said drag controller means is included in said GUI generating/managing means and wherein a display as to whether or not said drag-and-drop can be implemented is dynamically switched so as to provide said application.

3. The GUI processing system for performing an operation of an application which controls testing equipment as set forth in claim 1, further comprising:
command execution history stack means, said command execution history stack means including command storage means for managing a command storage, said command storage saving a command which executes an execution start process in storage means, push means for adding a new command to the tail of said command storage, pop means for fetching the command added to the tail of said command storage, and command execution history storage means for adding a command, which executes an execution start process by an operation using said pointing device, to said command storage by utilizing said push means, and operation undo means for executing an execution undo start process of the command fetched by said pop means of said command execution history stack means, and
wherein said command execution history stack means and said operation undo means are included in said GUI generating/managing means.

4. The GUI processing system for performing an operation of an application which controls testing equipment as set forth in claim 1, further comprising:
command undo history stack means, said command undo history stack means including command storage means for managing a command storage, said command storage saving a command which executes an execution start process in storage means, push means for adding a new command to the tail of said command storage, pop means for fetching the command added to the tail of said command storage, and
command undo history storage means for adding a command, which executes an execution undo start process by an operation using said pointing device, to said command storage by utilizing said push means; and
operation redo means for executing an execution start process of the command fetched by said pop means of said command undo history stack means, and
wherein said command undo history stack means and said operation redo means are included in said GUI generating/managing means.

5. The GUI processing system for performing an operation of an application which controls testing equipment as set forth in claim 3, further comprising:
command block execution means for selecting a particular block included in said command storage, reading a command in said block, and executing the execution start process for the commands in the order of registration, and
wherein said command block execution means is included in said GUI generating/managing means so that, in response to a demonstration operation, the execution start process for the commands held in said command storage is carried out again in the order of registration of the commands.

6. The GUI processing system for performing an operation of an application which controls testing equipment as set forth in claim 5, further comprising command block edit means for storing a particular block in said command storage in said storage means, deleting commands after a predetermined command stored in said block, and adding a new command, and wherein said command block edit means is included in said GUI generating/managing means so that, in response to the demonstration operation, the execution start process for the commands held in said command storage is carried out after the registered commands are partially edited.
